(19) United States
(12) Patent Application Publication
(10) Pub. No.: US 2010/0241723 A1
(43) Pub. Date: Sep. 23, 2010

(54) Computer-Implemented Delivery of Real-Time Participatory Experience of Localized Events

(76) Inventor: Hugh Dornbush, Brooklyn, NY (US)

Correspondence Address: Sunstein Kann Murphy & Timbers LLP, 125 SUMMER STREET, BOSTON, MA, 02110-1618, US

(21) Appl. No.: 12/725,770

(22) Filed: Mar. 17, 2010

Related U.S. Application Data
(60) Provisional application No. 61/160,984, filed on Mar. 17, 2009.

(51) Int. Cl. G06F 15/16; G06F 17/30

(52) U.S. Cl. 709/207; 707/E17.005; 707/802; 707/705

(57) ABSTRACT

A computer-implemented method provides a real-time participatory experience of localized event information. In one embodiment, the method includes receiving over a communications network a collection of messages, each message involving a localized event and storing messages of the collection. With respect to each message of the collection, the method further includes extracting an identity of the sender from the message, and updating a user database based on the sender's identity; parsing the message to derive a location from the message about the event; storing in an event database the derived location in association with the event; retrieving, from a user database, a list of users and notification parameters; and generating a contemporaneous alert reporting on information stored in the event database and causing the alert to be sent over the communications network to the users on the list in accordance with the notification parameters.

The present application claims priority from U.S. Provisional Application No. 61/160,984, filed Mar. 17, 2009, the full disclosure of which is hereby incorporated by reference herein.

### TECHNICAL FIELD

The present invention relates to computer-implemented systems and methods for handling information content in a social networking environment, and more particularly to computer-implemented delivery of real-time participatory experience of localized events.

### BACKGROUND ART

It is known in the prior art to publish celebrity gossip on a website. The daily lives of celebrities generate great interest among members of the public, including, but by no means limited to fans of the celebrities. Both publicly known facts and unsubstantiated rumors about celebrities often are discussed at great length by many people, and celebrity gossip websites (for example, tmz.com) seek out and report on public happenings involving celebrities and provide a forum for interested users to discuss these stories.

Also known in the prior art is the use of social networking services on mobile devices. Simplified versions of internet-based social networking services such as Facebook (facebook.com) and MySpace (myspace.com), optimized for use on mobile devices such as cell phones, have allowed users to connect to their social networks without the limitation of needing to use a local internet-connection on a desktop or laptop computer. Other social networking services were designed specifically for use on mobile devices, such as Google's Dodgeball (dodgeball.com), which allowed users to share their physical locations with members of their social networks.

### SUMMARY OF THE INVENTION

A first embodiment of the invention is a computer-implemented method of providing a real-time participatory experience of localized event information. In this embodiment, the method includes receiving over a communications network a collection of messages, each message involving a localized event and storing messages of the collection. With respect to each message of the collection, the method further includes in a first computer process, extracting an identity of the sender from the message, and updating a user database based on the sender's identity; in a second computer process, parsing the message to derive a location from the message about the event; storing in an event database the derived location in association with the event; retrieving, from a user database, a list of users and notification parameters; and in a third computer process, generating a contemporaneous alert reporting on information stored in the event database and causing the alert to be sent over the communications network to the users on the list in accordance with the notification parameters.

Another embodiment is a computer-implemented method of providing a real-time participatory experience of localized event information about celebrities, and the method includes receiving over a communications network a collection of messages, each message involving a celebrity in a localized event and storing messages of the collection. With respect to each message of the collection, the method also includes, in a first computer process, extracting an identity of the sender from the message, and updating a user database based on the sender's identity; in a second computer process, parsing the message (i) to associate the message with an identity of the celebrity and (ii) to derive a location from the message about the celebrity; storing in a celebrity database the derived location in association with the celebrity; retrieving, from a user database, a list of users and notification parameters; and in a third computer process, generating a contemporaneous alert reporting on information stored in the celebrity database and causing the alert to be sent over the communications network to the users on the list in accordance with the notification parameters.

In a related embodiment, the method further includes receiving over the communications network a communication from at least one of the users receiving the alert, such communication evaluative of content of the alert and updating the user database to reflect the evaluative communication. Optionally, the method includes updating the celebrity database to reflect the evaluative communication. Alternatively or in addition, the identity of the celebrity and the identity of the sender are distinct. Additionally or as a further alternative each message involving a celebrity in a localized event comprises a text message sent by a sender who has observed the celebrity in the localized event.

In a related embodiment, the method further includes operating a web server to cause publication of the event on a web site. Optionally, operating the web server to cause publication of the event on a web site includes for each of a set of words in the associated message, providing a link on the web site to content on the web site, the content being associated with the word.

In another related embodiment, updating the user database to reflect a communication evaluative of content of an alert includes adjusting at least one ranking for the sender of the alert. Optionally, updating the celebrity database to reflect the communication includes adjusting at least one ranking for the celebrity. Alternatively, or in addition, a communication evaluative of content of an alert includes a measure of relevance of the alert. As another alternative or another addition, a communication evaluative of content of an alert includes a measure of validity of the alert.

In another related embodiment, each message includes a user-generated description of the localized event. Optionally, the user-generated description of the localized event is not selected from a predetermined set of descriptions. According to another option the collection of messages includes at least one message containing a picture of a celebrity. Additionally, the picture of a celebrity may be a picture of the celebrity with a user. Alternatively, or in addition, the method further includes associating the picture of the celebrity with an identity of the celebrity and providing a link on the web site to content on the web site, the content being associated with the identity of the celebrity. As another possible addition or alternative the method further includes associating the picture of the celebrity and user with an identity of the user and providing a link on the web site to content on the web site, the content being associated with the identity of the user. The at least one picture message also may optionally include a text message.

In another related embodiment, the method further includes receiving over the communications network a message from a user receiving an alert, the message including a picture of the event.

Another embodiment is a system for providing a real-time participatory experience of localized event information about a celebrity. The system includes a communications interface configured to receive and send communications over a communications network via at least one of a message gateway and a web server, the communications including messages, each message involving a celebrity in a localized event. The system further includes a user database, a celebrity database, and an identity extractor, coupled to the communications interface, configured to extract an identity of a sender from each of the messages, and further configured to update the user database for each message based on an identity of a sender of the message. The system also includes a message parser, coupled to the communications interface, configured for each of the messages to parse the message (i) to associate the message with an identity of the celebrity and (ii) to derive a location from the message about the celebrity, and further configured to update the celebrity database based on the identity of the celebrity and the location. The system further includes a processing unit, configured to generate notification parameters and store the parameters in the user database and an alert generator, configured for each of the messages to retrieve from the user database (i) a list of users associated with the location, and (ii) notification parameters, and further configured for each of the messages to generate an alert reporting on the event and cause the alert to be sent over the communications network to the users on the list via at least the message gateway.

In a related embodiment, the processing unit is further configured to receive over the communications network via at least one of the message gateway and the web site a communication from at least one of the users receiving an alert, such communication evaluative of content of the alert, and update the user database to reflect the evaluative communication. Alternatively or in addition, the processing unit is further configured to update the celebrity database to reflect the evaluative communication.

In another related embodiment, the message gateway is an SMS gateway.

Another embodiment is a method of generating information relating to an online identity of a set of individuals. The method includes receiving over a communications network a collection of messages, each message involving a celebrity in a localized event and storing messages of the collection. The method further includes with respect to each message of the collection, in a first computer process, extracting an identity of the sender from the message, and updating a user database based on the sender's identity; in a second computer process, parsing the message (i) to associate the message with an identity of the celebrity and (ii) to derive a location from the message about the celebrity, storing in a celebrity database the derived location in association with the celebrity, retrieving, from a user database, a list of users and notification parameters, in a third computer process, generating a contemporaneous alert reporting on information stored in the celebrity database and causing the alert to be sent over the communications network to the users on the list in accordance with the notification parameters, receiving over the communications network a communication from at least one of the users receiving the alert, such communication evaluative of the content of the alert, and updating the user database and the celebrity database to reflect the evaluative communication. The method further includes receiving over the communications network, from a plurality of users, biographical summaries of the celebrity and assigning a ranking to each of the biographical summaries. The method further includes receiving over the communications network, from a user receiving the alert, a message requesting a biographical summary relating to the celebrity. The method further includes sending over the communications network, to the user requesting the summary, a message containing a biographical summary selected from the biographical summaries according to the rankings.

In a related embodiment, the method further includes receiving over the communications network, from the user requesting the summary, a communication evaluative of the summary and updating the ranking of the biographical summary according to the communication evaluative of the summary. Alternatively or in addition, the method includes receiving over the communications network, from the user requesting the summary, a message requesting a second biographical summary and sending over the communications network, to the user, a message containing a second biographical summary selected from the biographical summaries according to the rankings. According to another possible addition or alternative, the method includes updating the notification parameters based on the request for a biographical summary. Alternatively or in addition the method includes generating information relating to an online identity of a celebrity according to the number of biographical summaries received from users for the celebrity and storing the information relating to the online identity in the celebrity database.

### BRIEF DESCRIPTION OF THE DRAWINGS

The foregoing features of the invention will be more readily understood by reference to the following detailed description, taken with reference to the accompanying drawings, in which:

FIG. 1 is a schematic block diagram of a computer-implemented system that provides a participatory real-time experience of localized event information about celebrities in accordance with an embodiment of the present invention.

FIG. 2 is a flow chart of a method, which may be practiced by the system of FIG. 1, for providing a participatory real-time experience of localized event information in accordance with an embodiment of the present invention.

FIG. 3 is a flow chart of a method, similar to the method of FIG. 2, for providing a participatory real-time experience of localized event information about celebrities in accordance with an embodiment of the present invention.

FIG. 4 is a flow chart of a method, similar to that of FIG. 3, for using text messages in providing a participatory real-time experience of localized event information about celebrities in accordance with an embodiment of the present invention.

FIG. 5 is a flow chart of a process for maintaining notification parameters in the system of FIG. 1 in accordance with an embodiment of the present invention.

FIG. 6 is a flow chart of a process for maintaining biographical information of celebrities and notification parameters in the system of FIG. 1 in accordance with an embodiment of the present invention.

FIG. 7 is a flow chart of a method, similar to that of FIG. 4, for using picture messages in providing a participatory real-time experience of localized event information about celebrities in accordance with an embodiment of the present invention.

FIG. 8 is a flow chart of a method for using a text message to generate links to content in the system of FIG. 1 in accordance with an embodiment of the present invention.

FIG. 9 is a flow chart of a method, similar to the methods of FIG. 7 and FIG. 8, for using a picture message to generate links to content in the system of FIG. 1, in accordance with an embodiment of the present invention.

FIG. 10 is a flow chart of a process for weighting a celebrity sighting according to the reputation of the user reporting the sighting in the system of FIG. 1 in accordance with an embodiment of the present invention.

FIG. 11 is a flow chart of a subprocess used in the process of FIG. 10 for calculating an activity score for a user in accordance with an embodiment of the present invention.

FIG. 12 is a flow chart of a subprocess used in the process of FIG. 10 for calculating a location score for a user in accordance with an embodiment of the present invention.

FIG. 13 is a flow chart of a subprocess used in the process of FIG. 10 for calculating a community score for a user in accordance with an embodiment of the present invention.

FIG. 14 is a flow chart of a process for weighting a celebrity sighting according to the reputation of the celebrity in the system of FIG. 1 in accordance with an embodiment of the present invention.

FIG. 15 is a flow chart of a subprocess used in the process of FIG. 14 for calculating a celebrity score for a celebrity in accordance with an embodiment of the present invention.

FIG. 16 is a flow chart of a subprocess used in the process of FIG. 14 for calculating a celebrity response score for a celebrity in accordance with an embodiment of the present invention.

FIG. 17 is a flow chart of a subprocess used in the process of FIG. 14 for calculating a celebrity observed score for a celebrity in accordance with an embodiment of the present invention.

FIG. 18 is a flow chart of a subprocess for selectively delivering celebrity sighting alerts in the system of FIG. 1 in accordance with an embodiment of the present invention.

FIG. 19 is a flow chart of a subprocess used in the process of FIG. 18 for calculating a user sighting threshold in accordance with an embodiment of the present invention.

FIG. 20 is a flow chart of a subprocess used in the process of FIG. 18 for calculating a user-specific sighting score in accordance with an embodiment of the present invention.

FIG. 21 is a representation of a home page for a web site, served by the system of FIG. 1, having published celebrity sightings in accordance with an embodiment of the present invention.

FIG. 22 is a representation of a web page from the website of FIG. 21 showing a list of published celebrity sightings in accordance with an embodiment of the present invention.

FIG. 23 is a representation of a web page from the website of FIG. 21 showing details of a published celebrity sighting in accordance with an embodiment of the present invention.

FIG. 24 is a representation of a web page from the website of FIG. 21 showing a profile and list of recent sightings for a celebrity in accordance with an embodiment of the present invention.

FIG. 25 is a representation of a web page from the website of FIG. 21 showing a list of recent celebrity sightings of a user in accordance with an embodiment of the present invention.

FIG. 26 is a representation of a web page from the website of FIG. 21 showing a list of celebrity rankings in accordance with an embodiment of the present invention.

FIG. 27 is a representation of a web page from the website of FIG. 21 showing the results of a text search for content in accordance with an embodiment of the present invention.

FIG. 28 is a representation of a web page from the website of FIG. 21 where a user can opt in to alerts of celebrity sightings according to the geographical location of the sightings in accordance with an embodiment of the present invention.

FIG. 29 is a representation of a web page from the website of FIG. 21 inviting a user to opt in to alerts in a particular geographical location, and showing a list of celebrity sightings selected according to the geographical location of the sightings in accordance with an embodiment of the present invention.

FIG. 30 is a representation of a web page from the website of FIG. 21 confirming that a user has opted in to alerts in a particular geographical location, and showing a list of celebrity sightings selected according to the geographical location of the sightings in accordance with an embodiment of the present invention.

FIG. 31 is a representation of a web page from the website of FIG. 21 showing a profile of a celebrity including a biographical summary.

FIG. 32 is a representation of a web page from the website of FIG. 21 where a user can read user-generated biographical summaries for a celebrity.

FIG. 33 is a representation of a web page from the website of FIG. 21 where a user can write a biographical summary for a celebrity.

FIG. 34 is a representation of a web page from the website of FIG. 21 showing a published celebrity sighting including a picture of a celebrity with a user.

FIG. 35 is a representation of a web page from the website of FIG. 21 showing a published celebrity sighting where a user can tag a celebrity or a user in a picture.

FIG. 36 is a representation of a web page from the website of FIG. 21 showing multiple pictures of a celebrity associated with multiple published sightings of the celebrity.

FIG. 37 is a representation of a web page from the website of FIG. 21 showing a list of published celebrity sightings, in which one of the sightings includes pictures of the sighting.

### DETAILED DESCRIPTION OF SPECIFIC EMBODIMENTS

Definitions. As used in this description and the accompanying claims, the following terms shall have the meanings indicated, unless the context otherwise requires:

A “collection” of messages is a set of messages, the set having at least one member.

A “mobile client” is portable device, coupled wirelessly to a communications network, that enables a user thereof to send and receive messages over the network. The message may be in any of a variety of formats, including SMS, MMS, and e-mail protocols, such as POP and IMAP.

A “celebrity” is a person, character, animal, or animated object, having a physical existence, in the public eye. A dummy, such as Charlie McCarthy, in the hands of ventriloquist Edgar Bergen is a “celebrity” for purposes herein. Similarly, Mickey Mouse, when portrayed by an actor with no reputation in a mouse costume, is also a “celebrity” since the Mickey Mouse character is in the public eye and is here given a physical existence. One can be a “celebrity” for purposes herein without being widely known in all segments of the public as a whole; a “celebrity” may be someone known to an established niche group of the public, but who is essentially anonymous to the public as a whole. Veselin Topalov, a chess grandmaster who has held the title World Chess Champion, is known to essentially everyone with a serious interest in chess, and is therefore a “celebrity” for purposes herein, even though he is not as well known to that portion of the public that is not part of the chess community.

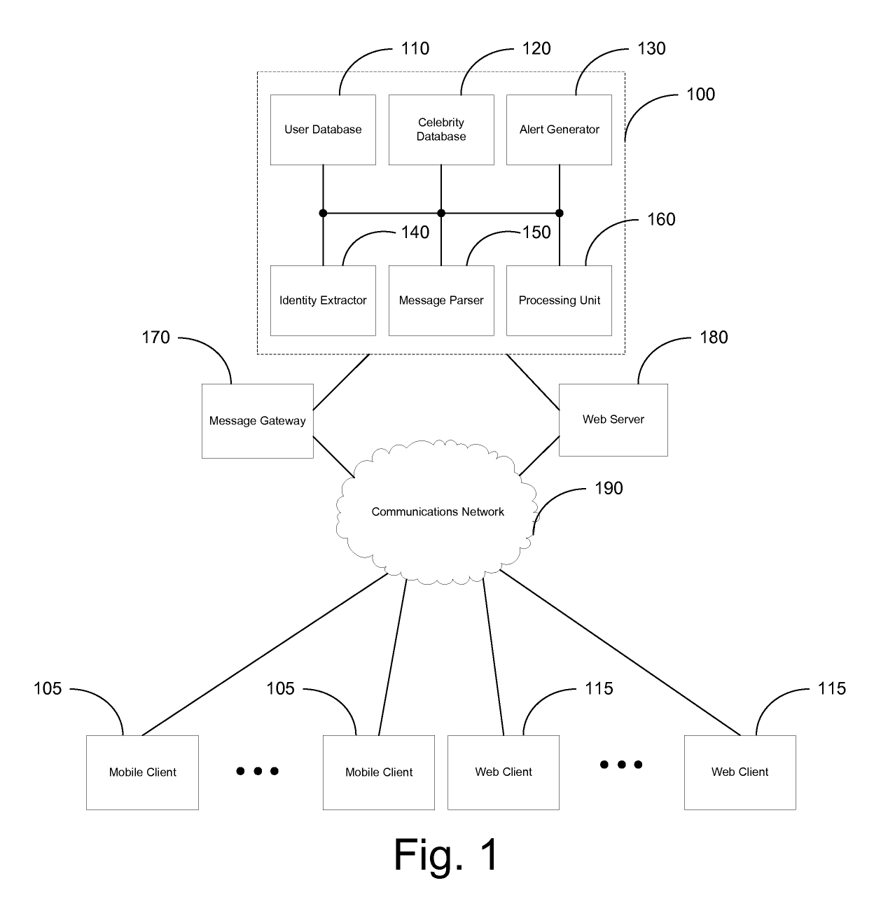

FIG. 1 is a schematic block diagram of a computer-implemented system that provides a participatory real-time experience of localized event information about celebrities in accordance with an embodiment of the present invention. A population of users of the system has mobile telephones represented in FIG. 1 as a series of mobile clients 105. Let us assume that one of the users has spotted a celebrity at restaurant X in New York, N.Y. This user uses his mobile client 105 to send a text message over communications network 190, of which a portion may include the internet, through message gateway 170, to system interface 100. (Message gateway 170 may be any gateway capable of receiving messages over a communications network, such as a Short Message System (SMS) gateway, a Multimedia Message Service (MMS) gateway, email server, etc.)

At this point, the system interface 100 of FIG. 1 operates to process the message so that the information in it can be deployed. The identity of the sender is extracted by identity extractor 140, and the resulting information is used by processing unit 160 to update user database 110. Similarly, content of the message is parsed by message parser 150, and is used by processing unit 160 to update celebrity database 120. Processing unit 160 runs a looping test on the contents of celebrity database 120, and when the test indicates conditions are ripe for sending an alert, processing unit 160 causes alert generator 130 to generate a text message alert concerning the presence of the celebrity at restaurant X in New York. The text message alert is sent, via message gateway 170 and communications network 190, to mobile clients 105 of users in user database 110 according to notification parameters that are stored in user database 110 for such users. Dots are used in FIG. 1 to indicate that a large number of mobile clients 105 and web clients 115 may be present, even though only two of each are shown.

Additionally, the web server 180 of FIG. 1 displays information content related to the celebrity and to the celebrity sighting. Information provided by web server 180 is made available over communications network 190 to web clients 115. Web clients 115 may be embodied in any devices capable of accessing the internet, such as personal computers running web browsers, public internet terminals, or internet-capable cell phones. Some devices, such as SMS- and internet-capable cell phones may be capable of functioning as both mobile clients and web clients if they are capable of both sending messages to message gateway 170 and connecting to web server 180.

Although we have referred above to mobile clients 105 represented in FIG. 1 as a series of mobile telephones, mobile clients 105 may be implemented by a variety of portable devices capable of sending messages, such as SMS- or MMS-capable cell phones, or personal digital assistants (PDAs). In certain embodiments, celebrity database 120 may be replaced by an event database.

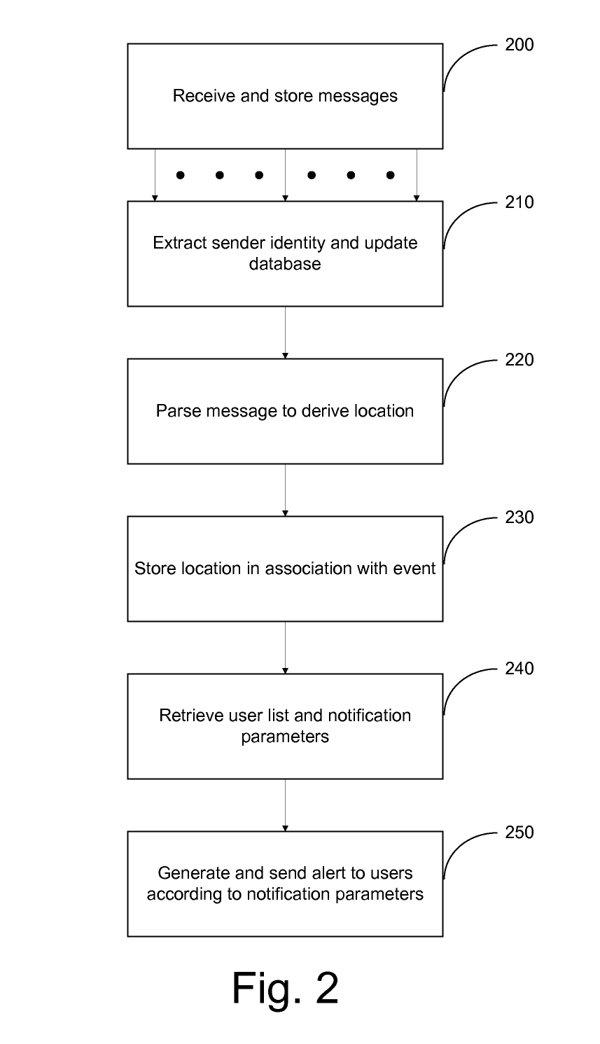

FIG. 2 is a flow chart of a method, which may be practiced by the system of FIG. 1, for providing a participatory real-time experience of localized event information in accordance with an embodiment of the present invention. From time to time, various users of the system experience interesting events as they go about their lives, and, like the user at the New York restaurant, described above, they send messages to the system documenting and sharing these experiences. Users may share their real-time experiences of a great variety of events, such as the user's experience of a public concert, which other users may wish to come see, or a user might discover that a group of people have gathered at a local frozen lake and that interested users could come join in an impromptu hockey match. Users could also report on more urgent matters, such as a traffic jam, or a disaster, such as a plane crash or a collapsed building, with the intention that other users either avoid the event for their convenience (e.g. traffic jam), or rush to the scene to provide emergency aid while professional rescuers are underway (e.g. plane crash), as circumstances warrant. In process 200, these messages are received and stored.

As shown in FIG. 2, processing is performed on each message separately. In process 210, the identity of the sender of the message is extracted from each message by identity extractor 140 of FIG. 1 and used by processing unit 160 to update a database. In certain embodiments of the invention, the database may be user database 110. In process 210, the user database is updated to reflect the sender's activities. Accordingly, if the sender has a history of sending such text messages, data for the sender in the user database 110 may reflect this history, for example, by a listing of participation dates and subjects or a parameter indicating frequency of participation. Such data may be used as an indicator of the sender's reliability and value within the context of the system. In process 220 the message is parsed by message parser 150 of FIG. 1 to derive a location. Parsing the message may include parsing text supplied by the sender as part of the message. Parsing the message also may include extracting information that is supplied automatically when the sender sends a message with a mobile client, such as GPS information provided by the mobile client or location information provided by a cellular telephone network. The location preferably describes where the event of interest is taking place, which will allow other users to pinpoint where the event is occurring in response to an alert—for example, to enable travel to the location, to provide a context for the event, and to enhance credibility of the report. In process 230, the location is stored in a database by processing unit 160 of FIG. 1 in association with the event.

The system must determine which users, if any, to alert regarding the reported event. As shown in FIG. 2, in process 240 a list of users and a set of notification parameters is retrieved from the system. In certain embodiments of the invention, these may be retrieved from user database 110 of FIG. 1 and either celebrity database 120 or optional event database. The notification parameters may be general parameters, used to decide whether or not any users should be notified. User-specific notification parameters also may be used advantageously to decide whether or not to notify a particular user. Exemplary notification parameters may include limits to what time of day users should receive notifications, or how many notifications should be sent per day. Notification decisions also may be made based on various measures of importance of the notification according to the associated event and location. Information about the sender of the message reporting on the event, such as the sender's reputation, also may be used as notification parameters. Assuming the message reporting the event is deemed important and reliable enough, and there are users whom the notification parameters indicate should be alerted, in process 250 an alert, notifying recipients about the specified event in the specified location, is generated and sent by alert generator 130 of FIG. 1 to the specified users through message gateway 170 and communications network 190.

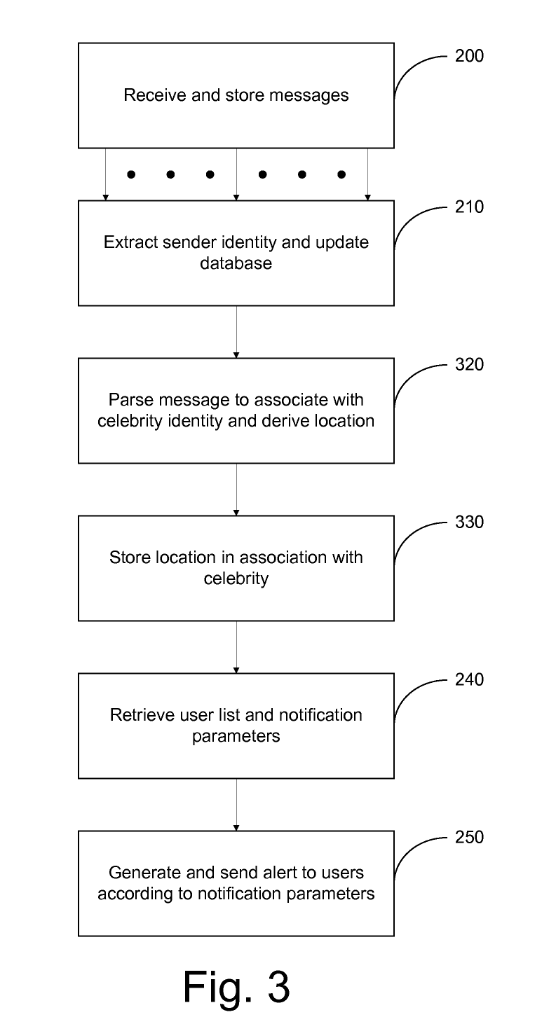

FIG. 3 is a flow chart of a method, similar to the method of FIG. 2, for providing a participatory real-time experience of localized event information about celebrities in accordance with an embodiment of the present invention. In other words, FIG. 2 is similar to FIG. 1, but made particular to localized event information about celebrities. As in the example of the user at the restaurant in New York described above in connection with FIG. 1, many users will periodically see celebrities of interest to the user community as they go about their lives, in which case the users send messages to the system reporting what was seen. As explained below, these messages may include any of text, pictures and video. In process 200 these messages are received and stored in the system, and the messages are each processed separately, as shown in FIG. 3. In process 210 the identity of the sender of the message is extracted by identity extractor 140 of FIG. 1 from each message, and a database is updated by processing unit 160 according to the message. In process 320 the message is parsed by message parser 150, resulting in the association of an identity of a celebrity with the message. A location also is derived by parsing the message. In process 330 the location is stored in association with the celebrity. In certain embodiments of the invention, this may take place in celebrity database 120 of FIG. 1.

The identity of the celebrity and the location of the event are used in developing notification parameters. Thus if a sighting is of a popular celebrity that a user has listed as her favorite actress, that user will probably receive an alert about the sighting. On the other hand, a less popular celebrity, or a celebrity about whom the user has shown little interest, is less likely to generate an alert to that user. As shown in FIG. 3, once a user list and notification parameters are retrieved in process 240, an alert is generated by alert generator 130 of FIG. 1 and sent 250 through message gateway 170 over communications network 190 to users according to the notification parameters.

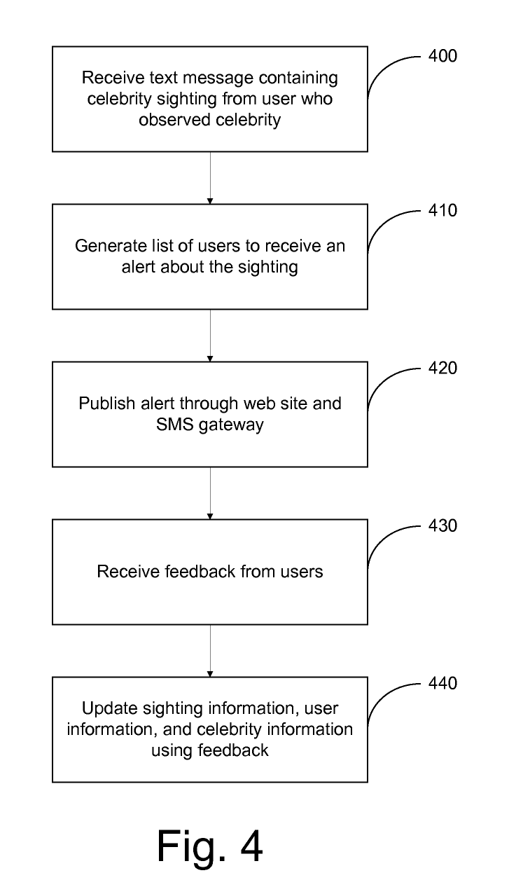

FIG. 4 is a flow chart of a method, similar to that of FIG. 3, for using text messages in providing a participatory real-time experience of localized event information about celebrities in accordance with an embodiment of the present invention. FIG. 4 is similar to FIG. 3, but further shows two fast and effective ways for users to interact with the system: sending and receiving text messages, and interacting with the web site associated with the system. A user observing a celebrity in a localized event sends a text message about the sighting, which is received in process 400 by the system. In certain embodiments of the invention, the message may be received through message gateway 170 of FIG. 1, implemented as an SMS gateway. In process 410 a list of users is generated, and in process 420 an alert is published, both through the web site and the SMS gateway. The web site preferably is served by web server 180. The alert sent through the SMS gateway in process 410 is sent as a text message to the users on the list that was generated. In process 430 the users receiving the alert are able to respond to the alert in a number of ways. Users may reply, for example via text message, picture message, video message, email, or through a web page, with information about the alert. The information about the alert may include how relevant or important the alert is to that user, an indication of whether the alert was accurate, or some other form of user feedback on the alert.

Suppose a user receives an alert about the celebrity at restaurant X and then goes to restaurant X hoping to catch a glimpse of this famous person, but celebrity X is not there. The disappointed user can then send a text message to the system reporting that the sighting was inaccurate, and other users may see the report that the sighting was inaccurate by viewing the website. In some embodiments, the system may generate a follow-up alert indicating that a prior alert is no longer considered valid. Users can consider the report from the scene before themselves deciding whether to venture over to restaurant X. On the other hand, suppose another user is sitting in a coffee shop across the street from restaurant X and receives the same alert. This time, suppose also that our celebrity is in fact eating dinner at a table on the sidewalk at restaurant X, but that this particular user has no interest in watching this particular celebrity eat dinner. The user could respond with a text message indicating that the report was accurate. The user also could respond by indicating that this particular alert was not something he finds interesting. This information could be used for several purposes. Similar alerts will be less likely to be sent to this user in the future, for one. Also, if enough users indicate that they are not interested, the celebrity in question may not be very popular, and will become less likely to trigger widely distributed alerts. Also, if a particular user tends to send messages about events that no one cares about, messages from that user will not be given as much weight as messages from other users.

As shown in FIG. 4, the user feedback is used in process 440 to update information about the celebrity sighting event, as well as information about both the user and the celebrity. The updated information can be used both for providing updated reporting on the event as it progresses, as well as for refining profiles of celebrities and users that can be used to determine more efficient notification parameters in the future. The information can further be used to develop online identities of the users and celebrities. For example, a celebrity profile may be developed, ranking a celebrity's popularity relative to other celebrities. A user profile may be developed, ranking a user's reputation in the online community for trustworthiness and value in developing and responding to celebrity sightings.

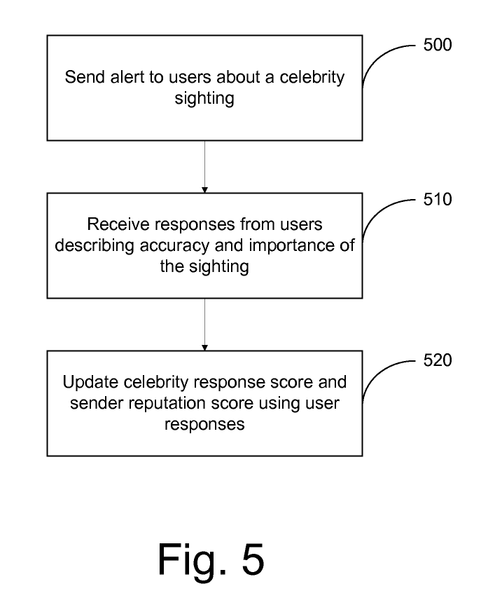

FIG. 5 is a flow chart of a process for maintaining notification parameters in the system of FIG. 1 in accordance with an embodiment of the present invention. In process 500 an alert is sent to users about a celebrity sighting. In process 510 responses are received from users. The responses may describe the accuracy of the sighting, i.e. is the alert correct. The responses also may describe the importance of the sighting. Unlike factual accuracy, this metric is subjective and will vary from user to user. Some users, for instance, may think that sightings of popular movie actors in public are important to them, because such events provide an opportunity to collect autographs. Other users may not be interested in getting autographs from movie actors, but might be very interested to hear about sightings of prominent local politicians, because they may want the chance to meet policymakers and share their opinions with them. Still other users may not care as much about actors or politicians, but will be interested to know that certain celebrities, possibly sports stars, are at a particular nightclub, because they believe that these celebrities attract good nightlife, or perhaps because they are known for buying drinks for fans.

In process 520 the user responses to the alerts are used to update scores for the celebrity in question and the sender of the sighting. For example, if a large volume of user responses are received for a particular celebrity, that celebrity is probably more popular than a celebrity who does not receive many user responses. Also, if a particular user tends to send sightings that other users say are accurate, it is more likely that a new sighting from the same user is accurate than a sighting from a user with no history or negative history.

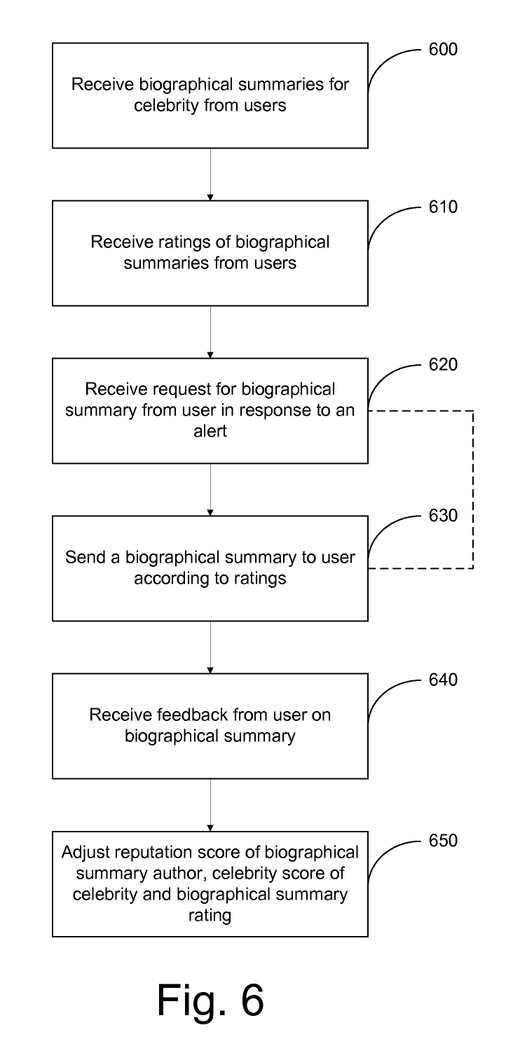

FIG. 6 is a flow chart of a process for maintaining biographical information of celebrities and notification parameters in the system of FIG. 1 in accordance with an embodiment of the present invention. In certain embodiments of the present invention, user-generated biographical summaries are maintained in the system. Biographical summaries enhance the user experience by helping users to recognize a greater variety of celebrities, as well as by providing further opportunities for users to contribute to creating the online identities of the celebrities. In process 600 biographical summaries for a celebrity are received from users. Ratings for the biographical summaries are then developed, preferably as in process 610 by receiving ratings from other users. Then when a user receives an alert about that celebrity, the user can respond in process 620 with a request for a biographical summary for that celebrity. This may be useful, for example, in the case that the user is unsure who the celebrity is.

As shown in FIG. 6, in process 630 a biographical summary is sent to the user, the biographical summary being selected from the available summaries for the celebrity in question according to the ratings of the summaries. In certain embodiments, the highest rated summary is sent. Other embodiments might select a summary at random from among the highest rated, such as the summaries rated in the top 10% of all submitted summaries. At this time certain embodiments may allow the optional step of the user requesting a second (and possibly third, etc.) biographical summary. This is particularly useful in the case where the user is still unsure about who the celebrity is, or if the user find the particular biographical summary unhelpful. For example, a biographical summary for an actress may indicate that the actress plays a leading role in a particular popular television show. Most users may be familiar with the show and find this summary helpful, but some users may not know the show in question. In that case, the user still might be familiar with the actress from, for example, a series of roles she played in independent films that are less well known than the television show, but which are mentioned in another high-rated biographical summary. Receiving a second biographical summary might then help the user to recognize the celebrity.

As shown in FIG. 6, after receiving a biographical summary, in process 640 the user can then respond to the biographical summary to indicate how accurate, helpful, interesting, well-written, etc. it is. In process 650 this user feedback is used to adjust scores and ratings for the author of the summary, the celebrity, and the summary itself. An author whose summary is rated highly, for example, is likely to be a more trustworthy and useful resource than an author whose summaries receive poor marks. A celebrity who receives an inordinate number of responses asking for a biographical summary might not be popular enough that he or she is well-known, and the celebrity's profile can be updated accordingly. And by adjusting the rating of the biographical summary, future requests for biographical summaries can be answered with the best of the available summaries.

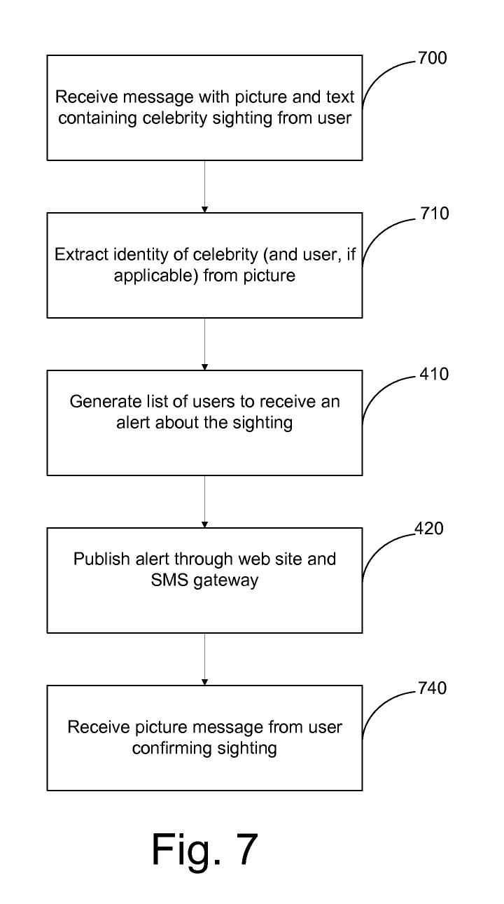

FIG. 7 is a flow chart of a method, similar to that of FIG. 4, for using picture messages in providing a participatory real-time experience of localized event information about celebrities in accordance with an embodiment of the present invention. In other words, FIG. 7 is similar to FIG. 4, but particularized to picture messages. By providing pictures in addition to possible text messages, users can provide more a engaging and a more credible experience of events they report. In process 700 a picture message (which may also contain text) reporting a celebrity sighting is received from a user. In process 710 the identity of the celebrity is extracted from the picture message by identity extractor 140 of FIG. 1. In some cases, pictures will include both a celebrity and a user, in which case the user's identity is also extracted.

In process 410 of FIG. 7 a list of users is generated, and in process 420 an alert is published through the web site and the SMS gateway. The alert sent through the SMS gateway is sent to the users on the list that was generated in process 410. In certain embodiments an MMS gateway may be used in addition to, or in place of the SMS gateway, for sending pictures. In process 740 a user receiving the alert can then investigate the sighting, and upon verifying the sighting may take a picture of the event and respond to the alert with the picture message. The picture then provides corroborating photographic evidence of the event. The picture also provides an alternative viewpoint of the event. Users viewing the alerts and pictures remotely, using, for example, cell phones or web browsers, may then experience different aspects of the event based on the different pictures of the event sent in by users. In certain embodiments, videos of the event may also be sent in by users, further enhancing the experience of the localized event for other users. FIG. 7 shows the specific case of a user's confirming a sighting with a picture message, in response to an alert generated in response to a picture message. It should be understood that users also may send picture messages or video messages confirming sightings that originally were reported via a text message not containing pictures or videos.

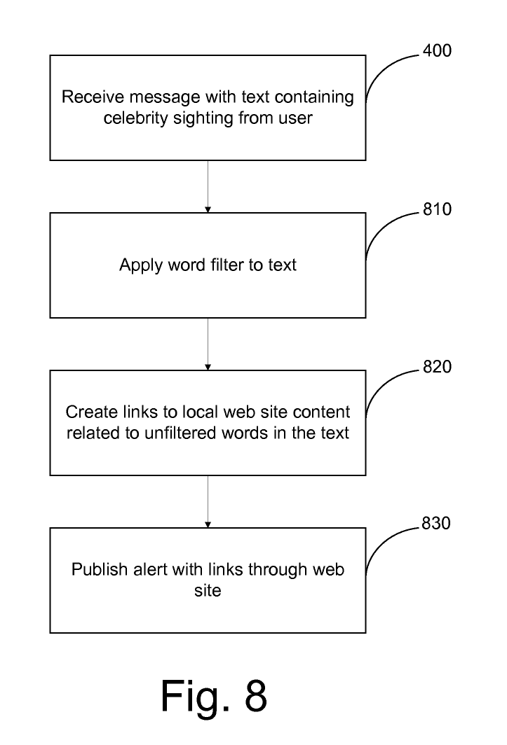

FIG. 8 is a flow chart of a method for using a text message to generate links to content in the system of FIG. 1 in accordance with an embodiment of the present invention. Often, different content stored in the system will be related in a useful way that users will want to exploit. For example, a celebrity may be the subject of multiple alerts. Multiple celebrities may have been spotted in one particular location. Or different alerts may describe a particular activity, such as signing autographs, that a user wants to know about. By creating an effective network of content links within the system, users can access this related content quickly and easily, starting from a single alert. In process 400 a text message is received via communications network 190 and message gateway 170 of FIG. 1 from a user observing a celebrity in a localized event. In process 810 the text of the message is filtered by processing unit 160 of FIG. 1 to remove certain common words such as “the,” “and,” “or,” etc. that do not by themselves describe the content of the message. In process 820 links are created by processing unit 160 of FIG. 1 using the remaining words, such that a user of the web site can follow the links from any one of the words to content on the web site that is associated with that word. In some embodiments, the links may be formed from concepts at a higher level than a single word. For example, if the text “Michael Phelps” appears in the message, a link may be created to content related to the Olympic swimmer by that name, but not to other, unrelated instances of the word “Michael.” In process 830 the alert and links are published together on the web site. When the text of the message is published as part of the alert, the entire, unfiltered text may be displayed on the web site, so that users viewing the website can more easily understand the content of the message, but the words that were filtered out do not form links to content.

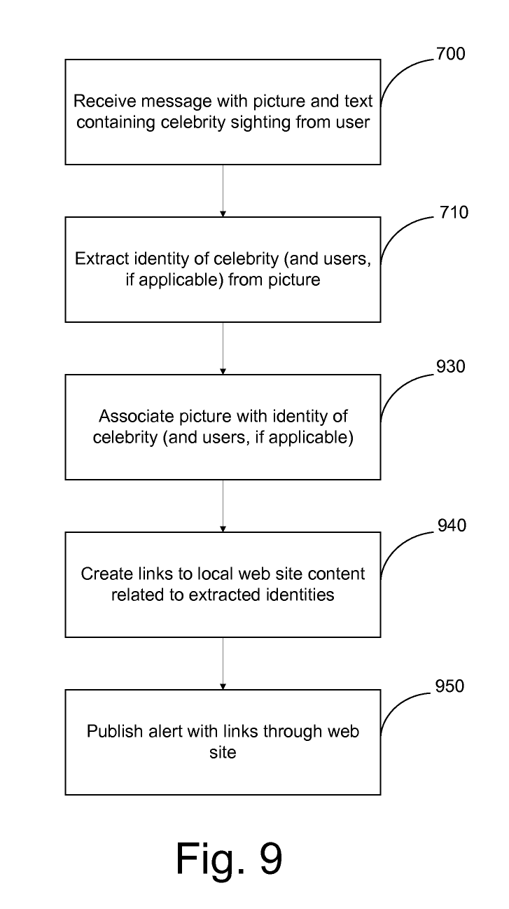

FIG. 9 is a flow chart of a method, similar to the methods of FIG. 7 and FIG. 8, for using a picture message to generate links to content in the system of FIG. 1, in accordance with an embodiment of the present invention. The method involves both the use of picture messages, as in the method of FIG. 7, and creating links to local content on the web site, as in the method of FIG. 8. Accordingly, users are able to navigate from pictures of celebrities (or users) whom they find interesting to related content on the website. In process 700 a picture message (which may also contain text) reporting a celebrity sighting is received from a user via communications network 190 and message gateway 170 of FIG. 1. In process 710 the identity of the celebrity is extracted from the picture message by identity extractor 140 of FIG. 1. In some cases, pictures will include both a celebrity and a user, in which case the user's identity is also extracted. In process 930 the identity of the celebrity (and the user, or users, if any) is associated with the picture. In process 940 links are created by processing unit 160 of FIG. 1, such that a user of the web site can follow the links from a web page with the picture to content on the web site relating to the extracted identities. In process 950 the alert and links are published together on the web site.

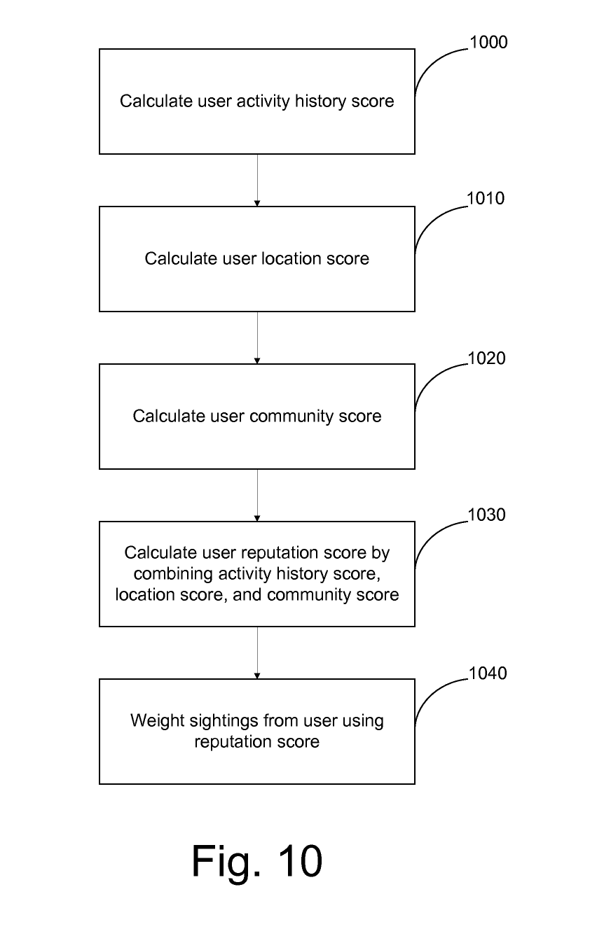

FIG. 10 is a flow chart of a process for weighting a celebrity sighting according to the reputation of the user reporting the sighting in the system of FIG. 1 in accordance with an embodiment of the present invention. When a user sends a message to the system reporting a celebrity sighting, the system must decide whether or not to generate an alert in response. Some users are likely to be more trustworthy, reliable, etc. than others, and it is preferred that messages from these users are given more weight than messages from less trusted users. In an embodiment of the present invention a reputation score is calculated and maintained for each user by calculating several metrics relating to the user and combining them to generate a reputation score. In process 1000 an activity history score is calculated for the user by processing unit 160 of FIG. 1. In process 1010 a location score is calculated for the user by processing unit 160. In process 1020 a community score is calculated for the user by processing unit 160. In process 1030 the activity history score, location score, and community score are combined by processing unit 160 to calculate a reputation score for the user. When the user sends a message to the system reporting a celebrity sighting, the sighting is weighted in process 1040 using the reputation score, so that the sighting is more likely to generate an alert for a more reputable user having a more favorable reputation score.

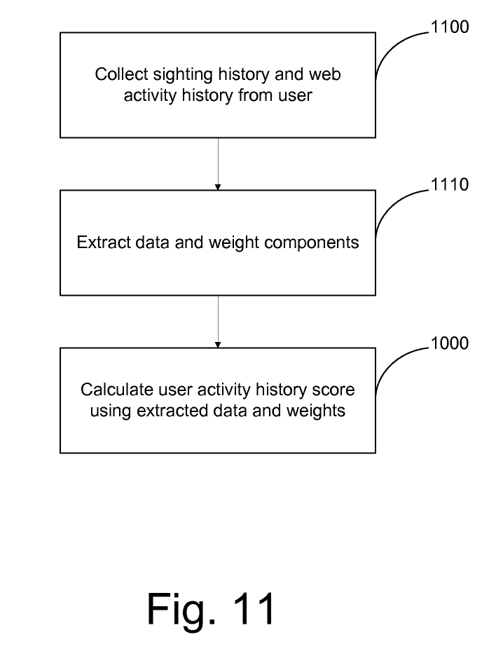

FIG. 11 is a flow chart of a subprocess used in the process of FIG. 10 for calculating an activity score for a user in accordance with an embodiment of the present invention. One of the ways the reliability of a user as a valuable contributor can be measured is by determining how frequently the user interacts with the system, and how long of a history the user has with the system. Someone who sends one message about a celebrity sighting per year might be reporting accurate and useful information—but there is not much of a track record to go on, either. Someone who sends a new celebrity sighting every few days and who regularly rates celebrities and comments on other users' sightings has a much more established history. The latter user also clearly is more personally invested in the virtual community of the system, and is more likely to understand the nuances of how users expect each other to act. For instance, if a custom develops that, e.g. the user base prefers celebrity sightings at planned celebrity events, such as movie premieres, be labeled differently in the text message than impromptu sightings, the regular user is more likely to have followed the social convention, and thus an alert from this user is more likely to be valued highly by the other users.

As shown in FIG. 11, in process 1100 the processing unit 160 of FIG. 1 collects the sighting history and web activity history for the user. In process 1110 raw data are extracted from the collected information, and the data points are weights the data components, allowing the system in process 1000 to calculate the user's activity history score.

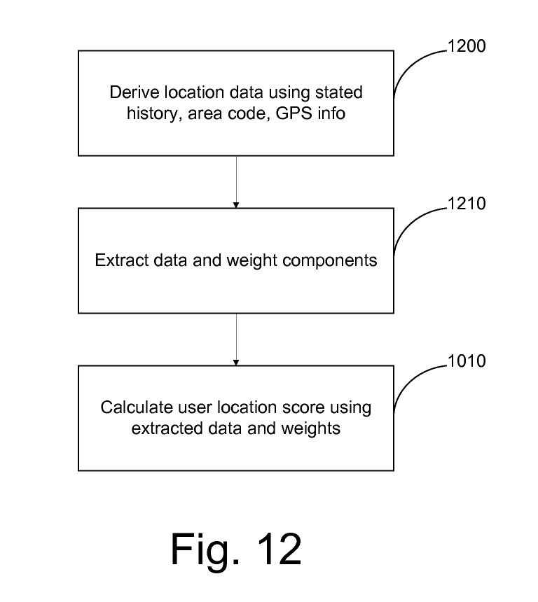

FIG. 12 is a flow chart of a subprocess used in the process of FIG. 10 for calculating a location score for a user in accordance with an embodiment of the present invention. A user's reliability as a source of information is evaluated using information about where the user resides. The phenomenon of celebrity sightings tends to be concentrated in certain cities, such as New York City, or Los Angeles, and users who are not physically present in such a locale are less likely to a) experience a celebrity sighting and b) be reporting from a location where significant numbers of other users would be able to go to the scene of the sighting to verify it. In process 1200 location data are derived for a user. These data may include the area code of the user's phone number, an actual location, as well as a recorded residence, provided by the user. The actual location may be derived using a variety of techniques, including deriving the location from a Global Positioning System (GPS) device in the user's mobile device, from a the user's cell phone network according to either nearest tower or triangulation methods, or from location derivation through WiFi networks. In process 1210 these data are extracted and assigned weights representing their relative importance by processing unit 160 of FIG. 1. For example, while an area code provides some indication as to a likely location, people may travel, and even change their states of residence, while taking a mobile phone with a single area code along. Thus, area code is only partially reliable for determining a person's actual location. A GPS signal, on the other hand, is presumably a better indicator of an actual location, and so it may be weighted more strongly. In process 1010 the extracted data and weights are used to calculate the user's location score.

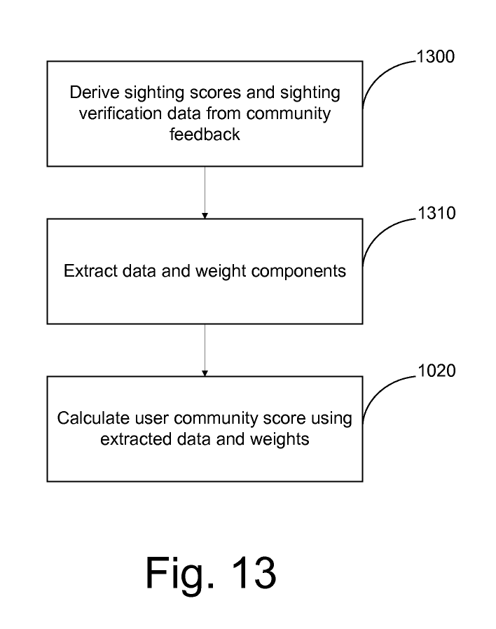

FIG. 13 is a flow chart of a subprocess used in the process of FIG. 10 for calculating a community score for a user in accordance with an embodiment of the present invention. Often, an especially effective way to determine a user's reliability is from feedback by other users. In process 1300 sighting scores and sighting verification data for a user are derived from community feedback.

After users receive alerts about celebrity sightings, they have the ability to give the sighting a positive or negative rating. This rating indicates how useful, interesting, etc. the sighting was. Based on a history of positive or negative responses to alerts resulting from messages a user sends to the system, the user's reputation can be adjusted accordingly.

After users receive alerts, they can respond to the alerts, indicating whether or not they were able to verify what was reported. Celebrity sightings that are verified by the community will increase a score. A history of sightings that no one can verify will affect a reputation negatively.

As shown in FIG. 13, in process 1310 data relating to feedback from other users to alerts generated from messages sent by a particular user reporting celebrity sightings are extracted, and they are weighted accordingly by processing unit 160 of FIG. 1. In process 1020 a user community score is calculated for the user using the extracted data and the weights.

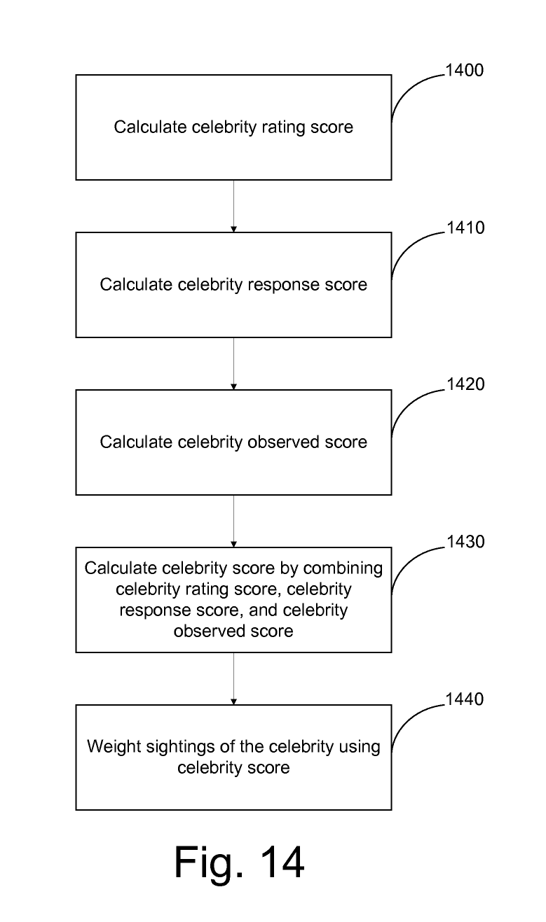

FIG. 14 is a flow chart of a process for weighting a celebrity sighting according to the reputation of the celebrity in the system of FIG. 1 in accordance with an embodiment of the present invention. An advantage of certain embodiments of the present invention is that users of the system are used in determining who is a celebrity, and how important celebrities are in relation to one another. These embodiments give fans, through their stated opinions and through their actions, voices to shape the selection of the famous. This selection process can be implemented by developing scores for weighting celebrity sightings.

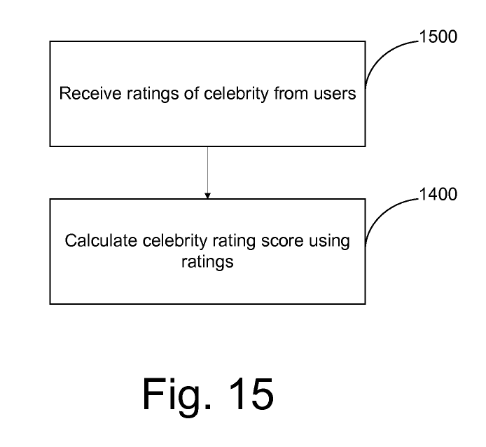

As shown in FIG. 14, in process 1400 a celebrity rating score is calculated. As FIG. 15 further illustrates, in process 1500 of FIG. 15, when a user encounters a celebrity on the web site, the user is given an opportunity to rate the celebrity, generating the ratings that are used in process 1400 to calculate the celebrity score. The rating can take the form of a numerical rating, e.g. between 1 and 4 stars, or alternatively from “A-list” to “D-list,” or on a scale of 1 to 10, etc. The user can also indicate that the person in question is not a celebrity at all. These interactions allow the system to learn about trends and preferences at both a user level and an aggregate level. An individual user's responses indicate what particular celebrities and what kind of celebrities are most interesting to that user.

At the same time, for the purposes of process 1400, the aggregated responses of the user community may be used to provide a measure of overall popularity for celebrities. Various statistical methods may be applied to this end, such as calculating an average of a celebrity's scores. The calculation may take into account factors such as a frequency of high or low responses (e.g. if a celebrity receives very high marks from a significant subset of users, but has an unimpressive overall average score, the celebrity may be more important to the community than a celebrity with the same average score but with fewer users giving a very high ranking).

The total number of people ranking a celebrity may be relevant also, in that a handful of high scores for a celebrity is probably less meaningful than a very large number of scores for another celebrity, even if the scores are, on average, lower, because an unpopular celebrity will not be likely to elicit ratings from so many users. The scores also may be considered as a function of time. As more users rate celebrities, the ratings may rise or fall quickly, and useful comparisons may be made between e.g. a celebrity whose “star is on the rise,” as opposed to a celebrity who is falling out of favor quickly or is falling out of the public eye.

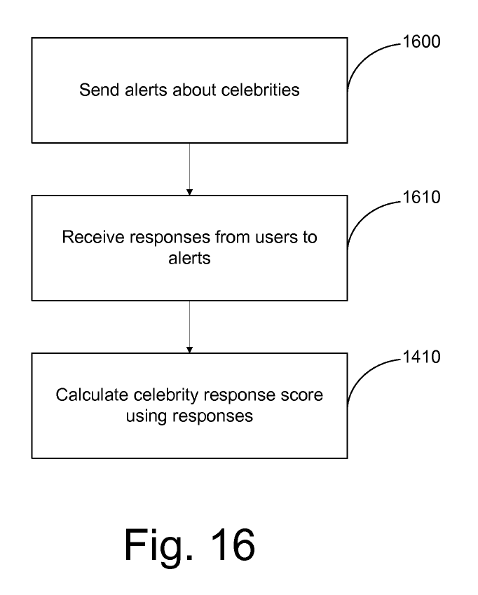

In process 1410 of FIG. 14 a celebrity response score is calculated by processing unit 160 of FIG. 1. In order to understand the calculation of the celebrity response score, we shall turn to FIG. 16, which involves, among other things, user response. When an alert about a celebrity sighting is sent to users in process 1600 of FIG. 16, users may respond, via SMS, email, web interface, etc. These responses are received in process 1610 of FIG. 16 and are used to calculate the celebrity response score in process 1410. User responses may indicate how important the sighting is to them. Generally speaking, positive responses are an indicator of a popular celebrity, and negative responses are an indicator of a celebrity being less popular, because most users will find alerts to be more or less important based on how much they like the celebrity in question. However, this indicator is somewhat less reliable than a direct rating of the celebrity (and a weighting of scores should reflect this). This is because the user's reaction will also take into account the content of the alert, and not just the identity of the celebrity in question. An alert indicating that a popular celebrity is sleeping in a hotel room, while it could both be accurate and refer to a very popular celebrity, may be of limited value because there is no immediate opportunity to go see the celebrity, nothing in particular is happening at present, etc. However, suppose a celebrity who is moderately popular is seen walking on a tightrope between skyscrapers in New York City. That alert may be of much greater interest than the alert about the sleeping A-list celebrity, because it concerns a public spectacle that many people might be able to observe in person if they so choose.

In process 1610 of FIG. 16, users also may respond to an alert by verifying or denying the validity of the sighting. Presumably, the more people who show up in the hopes of catching glimpse of someone, the more people care about that celebrity. Regardless of whether the celebrity is seen or not, the percentage of people receiving an alert who respond in this way should indicate how many people showed up when they received news about that person. A higher percentage of respondents indicates that more people showed up, and as a result, that more people care about the celebrity in question.

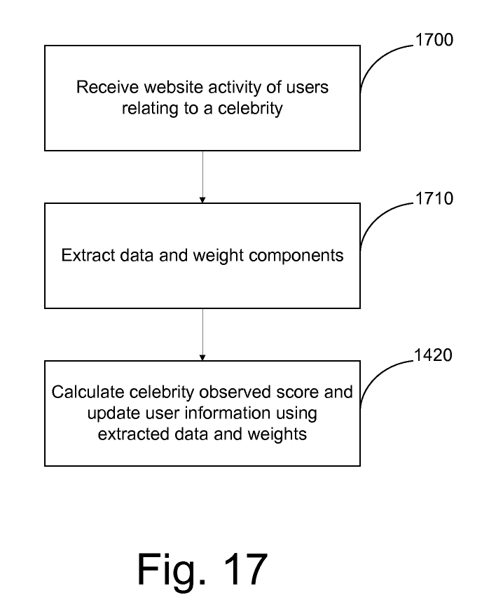

In process 1420 of FIG. 14, a celebrity observed score is calculated. Calculation of the celebrity observed score is shown in further detail in FIG. 17. In process 1700 of FIG. 17, website activity of users relating to the celebrity is received. One form of website activity is opting-in to receive information about a celebrity. The number of people who explicitly opt-in to receive information about a certain celebrity will affect that celebrity's celebrity score. Two people may have the same ratings as determined by users, but if one garners a much higher following, this popularity will have a positive effect on the celebrity score. In process 1710 of FIG. 17 the data relating to website activity are extracted and weights are derived, and the data and weights are used in process 1420 to calculate the celebrity observed score for the celebrity.

Returning to FIG. 14, in process 1430 an overall celebrity score is calculated by processing unit 160 of FIG. 1 using the celebrity rating score, the celebrity response score, and the celebrity observed score. The celebrity score is used in process 1440 to weight sightings of the celebrity to determine whether to generate an alert about the celebrity in response to a message reporting a sighting.

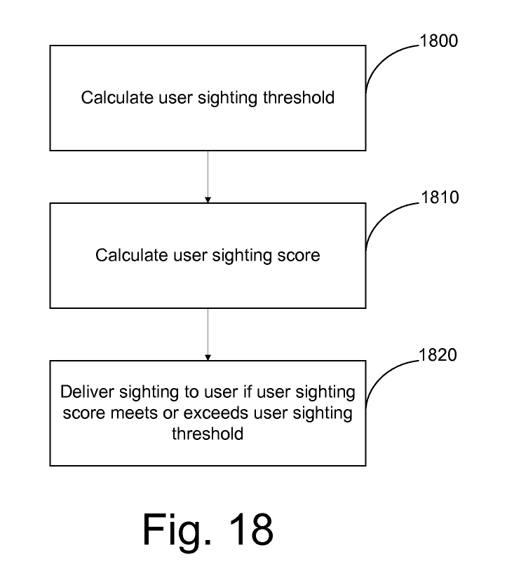

FIG. 18 is a flow chart of a process for selectively delivering celebrity sighting alerts in the system of FIG. 1 in accordance with an embodiment of the present invention. In an active and robust user environment, there may be a large volume of sighting messages sent to the system. It may be preferred to limit the number of alerts that are sent to individual users to a reasonable number per day. One way to achieve this would be simply to stop sending messages to a user once that user has received a daily quota. It is even better, however, to fine tune the delivery preferences for each user, so that users receive not just the first messages of the day, but the best, according to their individual preferences. User preference for delivery of messages is implemented by setting a threshold score, below which a user is not alerted, calculating a score for each sighting relative to the user, and only delivering a message relating to the sighting if the threshold is met.

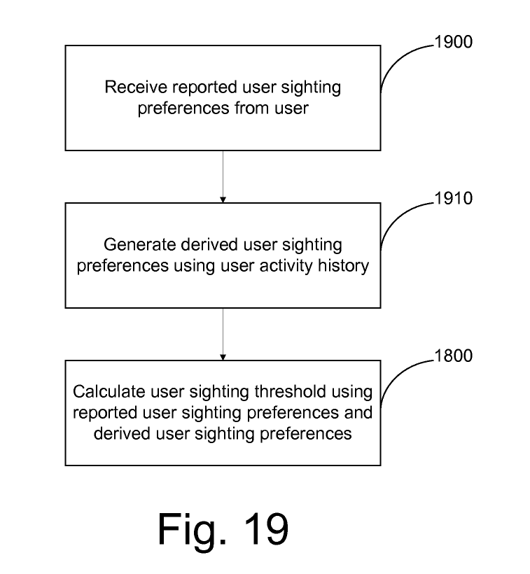

As shown in FIG. 18, in process 1800 a user sighting threshold is calculated. Calculation of the user sighting threshold is shown in greater detail in FIG. 19. In process 1900 of FIG. 19, sighting preferences are received from the user. One important preference the user can provide is a daily maximum number of alerts to receive. In embodiments where users receive alerts via text message, some users may want to limit the total number of text messages from the system, because receiving more text messages may cause users to incur charges from the wireless service provider. Other users may want to receive the most interesting alerts, but do not want their phones to beep all day long with minor alerts.

Additionally, for the purposes of process 1900 users may specify a time window during which the user wishes to receive messages. Some users may want to be alerted any time, day or night, if an exciting celebrity sighting happens. Some may not want to be alerted at night while they are sleeping, and others might not want to be alerted during certain times of the day while they are busy at work or at school.

For the purposes of process 1900 users also may indicate their preferences as to how popular a celebrity should be to trigger an alert. Some users may prefer to receive alerts only when A-list celebrities are spotted. Other users may wish to see A-list and B-list celebrity sighting alerts, and other users may want to see any level of celebrity sighting.

Further for the purpose of process 1900 users may indicate their preferences as to what kinds of celebrities they find most interesting. This information is used in conjunction with metrics of how many celebrities of different types are known in the system. For example, there may be celebrity profiles for a great number of movie actresses, but very few profiles of jockeys. Thus, when a jockey is spotted, a user who is interested in horse racing will be rather likely to receive an alert. By contrast, if a user is interested in movie actresses, and a movie actress is sighted, it is less critical that the sighting be sent to the interested user, because there are more possibilities for actresses to be sighted. For the calculation relating to the jockey, the scarcity of potential jockey sightings is likely to outweigh other considerations, such as overall celebrity rating, because the user has indicated an interest in horse racing celebrities. In the case of the movie actress, considerations such as celebrity rating are more likely to be decisive, because there are more potential alerts to choose from.

User preferences as to particular types of celebrities are derived both from explicit user input as in process 1900, and from implied user preferences, derived from user's interactions with the system in process 1910. On the one hand, a user may tell the system that he is interested in horse racing celebrities, but that he is not interested in basketball players. Similar preferences also may be implied by a user's website activity, responses to alerts, biographies written, etc. For example, a user who writes a biographical summary about a jockey is more likely to be a horse racing fan than average. If that same user also has reported sightings of jockeys, given celebrity ratings for jockeys on the website, and responded with confirmation of jockey sightings, it is all but certain that the user is a big horse racing fan. On the other hand, if a user has no recorded activity relating to ice hockey players other than responding to alerts about hockey players by indicating that he is not interested, it is relatively less likely that the user is interested in sightings of hockey players. The reported user sighting preferences and derived user sighting preferences can then be used to calculate the user sighting threshold in process 1800.

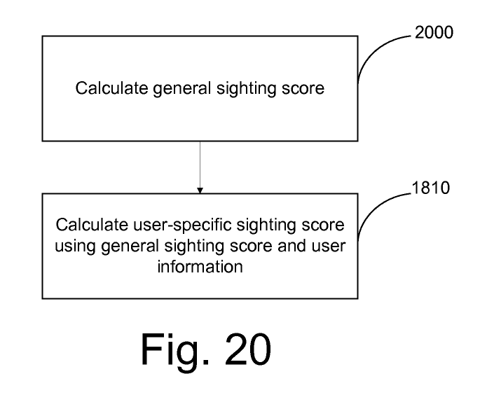

Returning to FIG. 18, in process 1810 a user sighting score is calculated. Calculation of the user sighting score is shown in greater detail in FIG. 20. The user sighting score indicates how significant a particular sighting is likely to be for a particular user. A score representing general information about the sighting is calculated in process 2000. One source of information for the general sighting score is the reputation score of the user reporting the sighting. As discussed previously, the more reputable the sender, the more likely the sighting is to be accurate and interesting. Another source of information for the general sighting score is the celebrity score of the celebrity in question. The more popular the celebrity, the more likely users in general are to be interested in sightings concerning that celebrity.

In process 1810 the user-specific sighting score is calculated by combining the general sighting score with user-specific information to calculate a score that is more accurate with respect to the user in question. The user-specific sighting score incorporates the user's demonstrated preferences such as whether the user likes the particular celebrity, and whether the user likes celebrities of the same kind as the celebrity in the alert. The user-specific sighting score also incorporates the user's location, to the extent it can be determined. The closer the sighting is to a particular user, the more likely the sighting is to be relevant to the user.

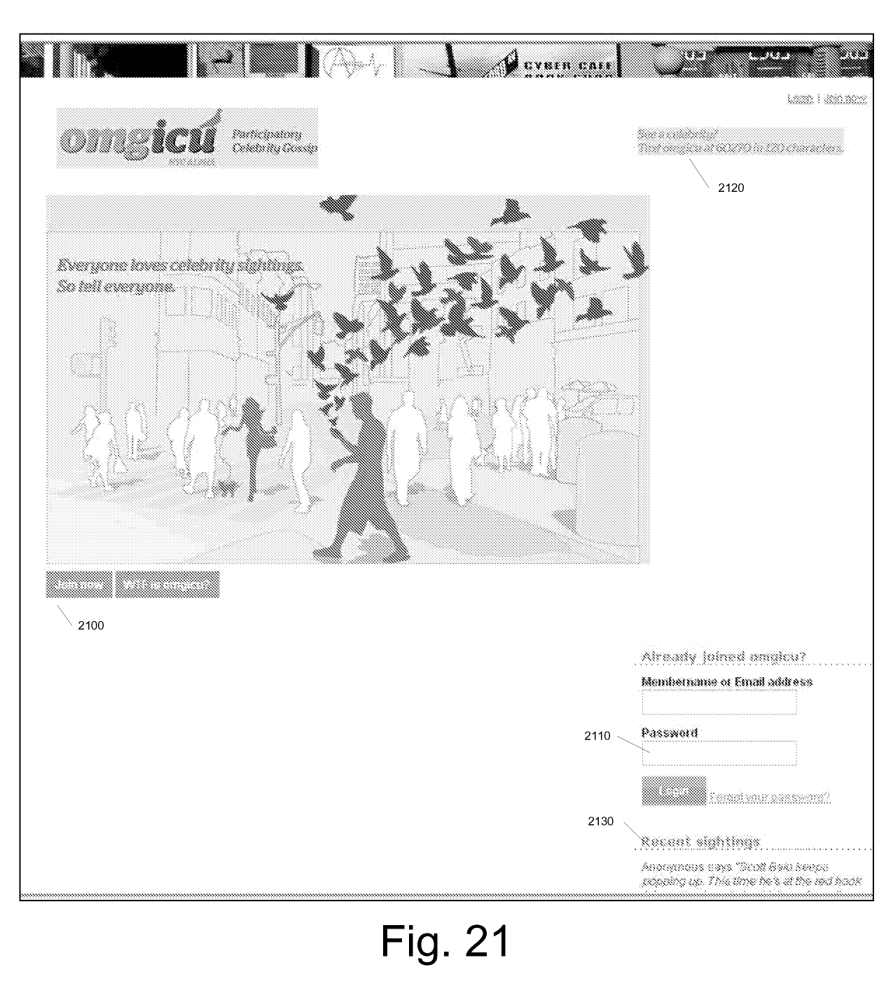

FIG. 21 is a representation of a home page for a web site, served by the system of FIG. 1, having published celebrity sightings in accordance with an embodiment of the present invention. Web server 180 of FIG. 1 serves a web site by which users can view celebrity sightings, rate celebrities, respond to celebrity sightings, etc. When a user loads the home page of the web site, the user will be able to become a member of the website by following signup link 2100 to a signup page. If the user already is a member of the website, the user can log into the website through login prompt 2110 by entering the appropriate login credentials. The home page also may include sighting reporting information 2120, advising visitors to the website as to how they can report celebrity sightings. In the embodiment shown in FIG. 21, visitors are instructed to send a text message to an SMS short code. The home page also may show one or more recent celebrity sightings in recent sightings listing 2130, allowing visitors to the website to see the most recent sightings immediately, without first having to navigate to a specific sighting page. The use of recent sightings listing 2130 also allows first time visitors to the web site to get an idea of the sort of content that the web site offers.

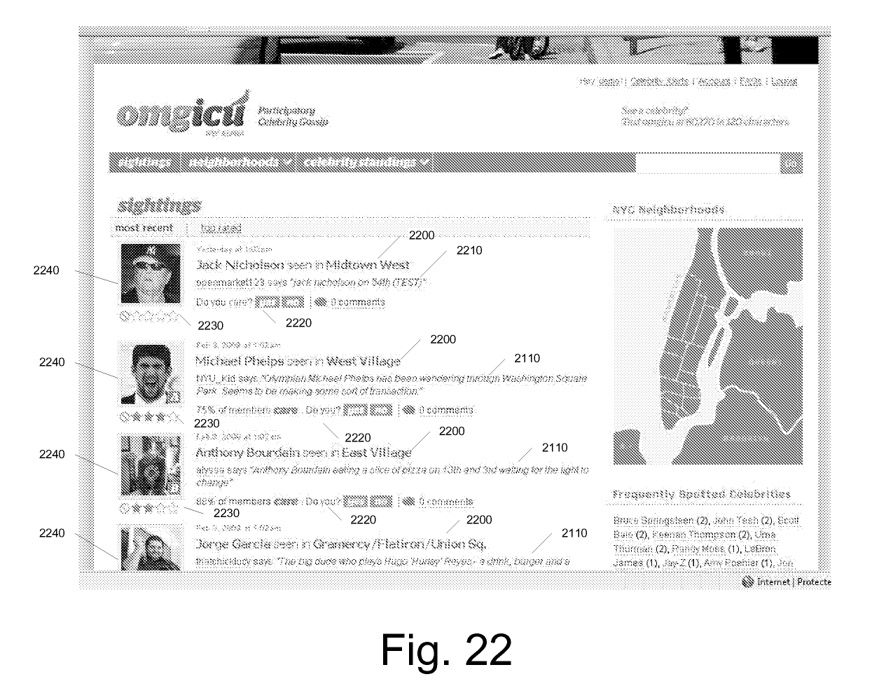

FIG. 22 is a representation of a web page from the website of FIG. 21 showing a list of published celebrity sightings in accordance with an embodiment of the present invention. Each published celebrity sighting may include information about a celebrity sighting indicating who the celebrity is, where and when the celebrity was seen, and what the celebrity was seen doing. A celebrity sighting location 2200 provides the most basic information of who was seen and where. For example, a celebrity sighting location 2200 may indicate that Jack Nicholson was seen in Midtown West. A user seeing this sighting may quickly determine whether this sighting will or will not be personally relevant. A user who is nowhere near Midtown West will know that traveling to investigate the sighting will be impractical. Likewise, a user who is not interested in Jack Nicholson will know right away that the sighting is of no interest based on this small amount of information.

A celebrity sighting description 2210 in FIG. 22 provides a greater degree of detail about the celebrity sighting than celebrity sighting location 2200. When a user submits a celebrity sighting via text message, the text message may include interesting details about the sighting, including what the celebrity was seen doing. The content of the text message may include any information that the user thinks is most interesting and useful in providing real-time experience of the sighting event to other users. The information could include reporting simply that the celebrity was seen shopping, or eating lunch. In other cases, the information could include a description of a celebrity's new hairstyle or style of dress. The information also could include a description of a more involved event such as if the celebrity is signing autographs, giving a public musical performance, etc. Other kinds of information that might be of interest could include a description of additional persons who are accompanying a celebrity, such as a new, previously unidentified significant other.

Also shown in FIG. 22 are user feedback buttons 2220. Users of the web site can respond to published celebrity sightings by indicating whether the sighting is of interest or not. In the embodiment shown in FIG. 22, a user is prompted with a question such as “Do you care?” The user can respond to the question about the sighting by clicking “yes” or “no” on the user feedback buttons 2220 associated with the sighting. When users express their interest or lack of interest, the published sighting is updated to include a recalculated percentage, indicating what fraction of voting users found the sighting to be of interest. These votes can be used in process 510 of FIG. 5, process 1610 of FIG. 16, and process 1910 of FIG. 19 as described above to calculate user reputation scores, celebrity response scores, and user sighting preferences.

FIG. 22 also shows celebrity rating inputs 2230 that users may use to indicate how interesting a particular celebrity is to the user. In the embodiment shown in FIG. 22, users can rate celebrities on a scale of 1-star to 4-star, with an additional option of declaring that the person shown is “not a celebrity,” indicated here by a circle with a line through the middle. The celebrity ratings thus collected can be used in process 1500 of FIG. 15 and process 1910 of FIG. 19 as described above to calculate celebrity scores and user sighting preferences.

Other information displayed on the web page shown in FIG. 22 includes celebrity profile pictures 2240 for the celebrities shown in the list of published celebrity sightings. In some embodiments of the present invention, the picture shown may be selected by a system administrator. Some celebrities may elect to provide a publicity photo to the system administrator for use as a celebrity profile picture 2240. In other cases, a stock photo may be used, or if no picture is available, the celebrity profile picture may be blank. In other embodiments, the picture shown may be provided by the user reporting the sighting in a picture message in process 700 of FIG. 7, as described above. As shown in FIG. 22, celebrity profile pictures 2240 may include an indicator of the celebrity's relative popularity (e.g. A-list, B-list).

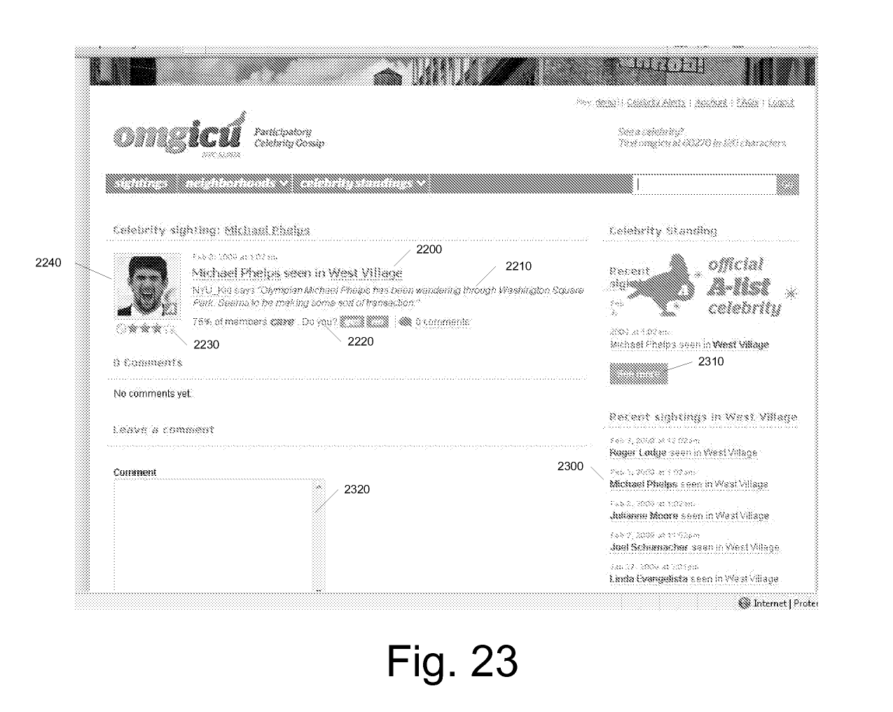

FIG. 23 is a representation of a web page from the website of FIG. 21 showing details of a published celebrity sighting in accordance with an embodiment of the present invention. Details of a selected celebrity sighting are given on a web page providing links to related content. If a user finds a particular celebrity sighting interesting, the user can navigate to the web page showing the details of the celebrity sighting for more information, and to read and write comments on the sighting. The celebrity sighting location 2200, celebrity sighting description 2210, user feedback buttons 2220, celebrity rating inputs 2230, and celebrity profile picture 2240 for the selected celebrity sighting are provided. Additionally, users can leave comments on the sighting using comment entry box 2320. This capability provides for community discussions of the most interesting sightings, which is especially useful for those users who find the sighting interesting, but are unable to travel to experience the event in person. The text of celebrity sighting location 2200 and celebrity sighting description 2210 in FIG. 23 also can be used in process 820 of FIG. 8 to create links to site content relating to the important words of the text.

The web page shown in FIG. 23 also includes links to content related to the selected celebrity sighting. A list of geographically-related sightings 2300 is shown. One reason why a user might navigate to the current web page is because the selected sighting occurred in close geographic proximity to the user. In that case, the user may want to know of other celebrity sightings that have occurred recently in the same general area. If one of the sightings shown in geographically-related sightings 2300 is of interest, the user can click on the sighting and navigate to a web page showing details of that sighting.

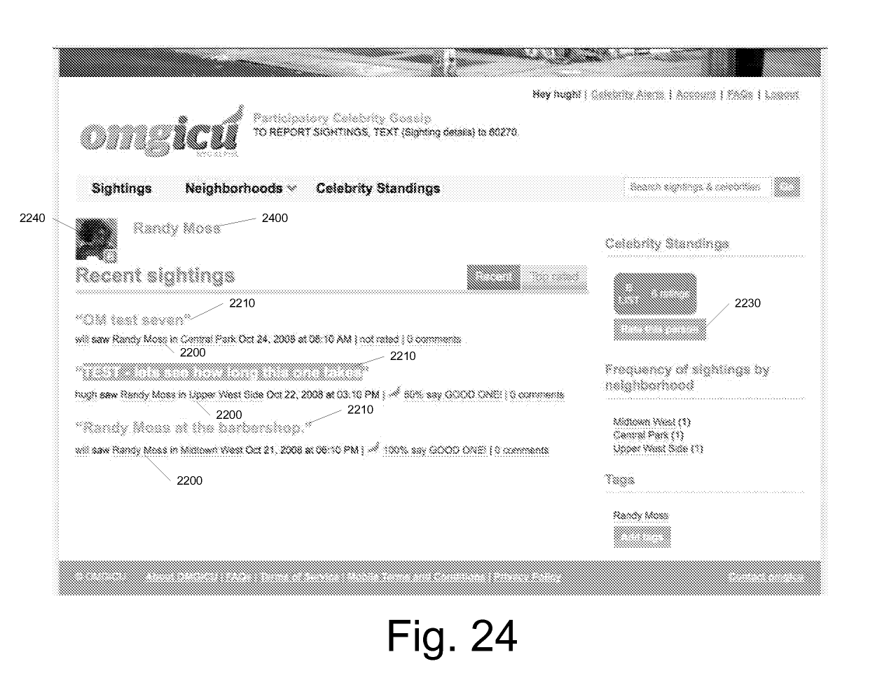

In addition to geographically-related sightings, a user might have navigated to the web page showing details about a celebrity sighting because the user is interested in that particular celebrity. In that case, the user might want to know about other sightings of that celebrity. By clicking on button 2310, the user can navigate to a web page listing recent sightings of the celebrity in question. Such a web page is described below with reference to FIG. 24.

FIG. 24 is a representation of a web page from the website of FIG. 21 showing a profile and list of recent sightings for a celebrity in accordance with an embodiment of the present invention. Heading 2400 indicates that this particular page contains recent sightings of Randy Moss. By clicking on any of celebrity sighting locations 2200 or celebrity sighting descriptions 2210 a user can navigate to a web page similar to the one shown in FIG. 23, showing details about that particular sighting. Similar pages to the one shown in FIG. 24 could be reached for any other celebrity for whom information exists in celebrity database 120 of FIG. 1. FIG. 24 also shows a different possible implementation of celebrity rating input 2230 from that shown in FIG. 22.

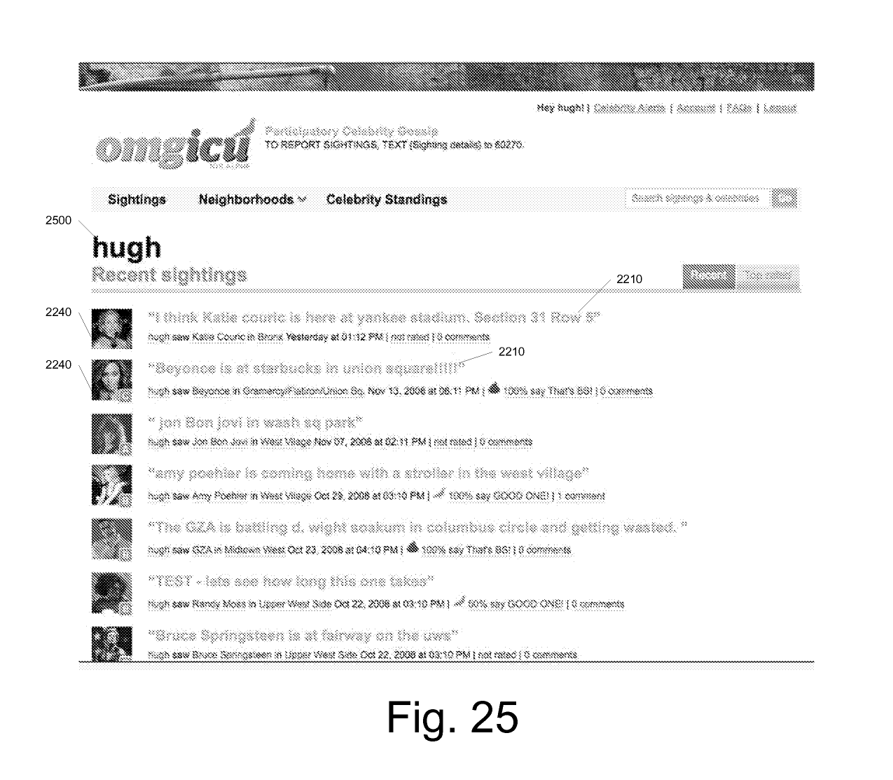

FIG. 25 is a representation of a web page from the website of FIG. 21 showing a list of recent celebrity sightings of a user in accordance with an embodiment of the present invention. Heading 2500 indicates that this particular page contains recent sightings reported by hugh. Users may wish to see a list of sightings reported by a particular user. For example, a user might want to see all the celebrity sightings that she herself has reported. Other users might see a particularly interesting sighting by a user and want to see what other sightings that user has posted in the past, thinking that they might be interesting as well. This list could be used to judge the general quality of sighting that users can expect from that user.

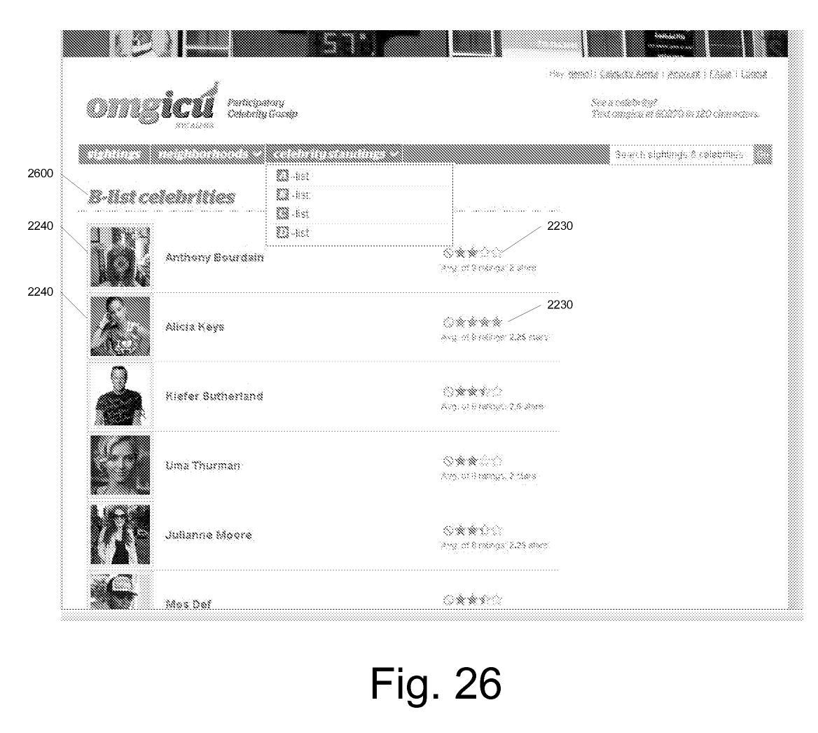

FIG. 26 is a representation of a web page from the website of FIG. 21 showing a list of celebrity rankings in accordance with an embodiment of the present invention. According to certain embodiments, celebrity ratings are used to classify celebrities as A-list, B-list, C-list, and D-list, with A-list celebrities being the most popular, and D-list celebrities being the least popular. Heading 2600 indicates that this particular page contains B-list celebrities. From such a celebrity rating page, a user can enter the user's personal preferences and opinions as to how much the user likes the celebrities shown, using celebrity rating inputs 2230.

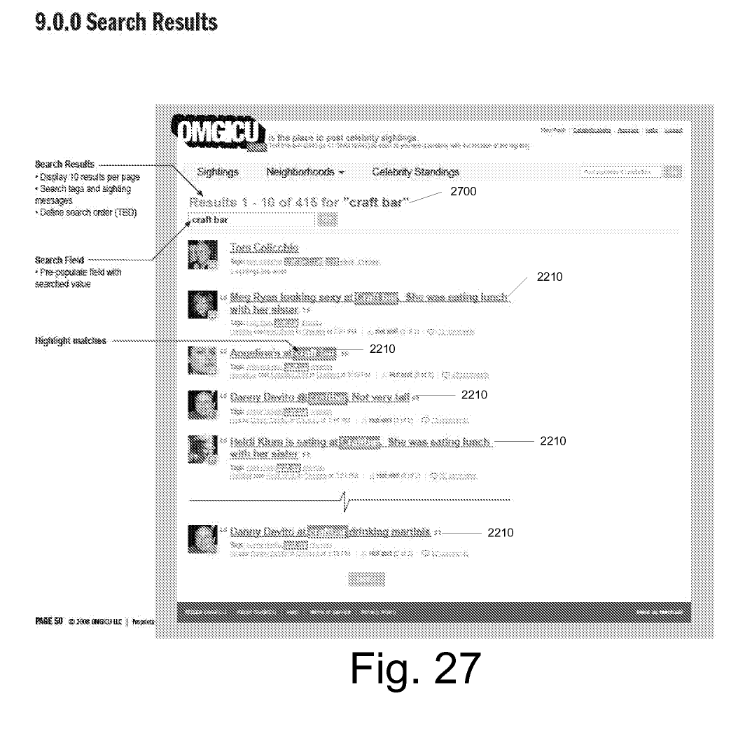

FIG. 27 is a representation of a web page from the website of FIG. 21 showing the results of a text search for content in accordance with an embodiment of the present invention. In many cases, users will know that they are interested in sightings having to do with a specific location, person, activity, etc. and it will be preferred to allow the user to perform a text search of all sightings for matches. Heading 2700 indicates that FIG. 27 shows the results of a text search for the search string “craft bar.” Several sightings are shown, including celebrity sighting descriptions 2210 containing the search string.

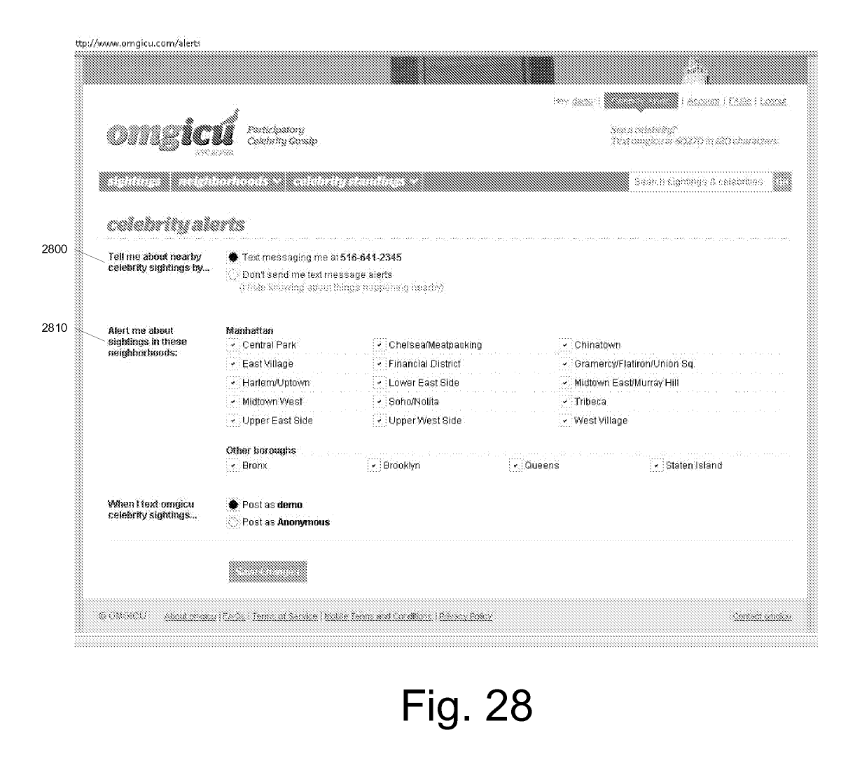

FIG. 28 is a representation of a web page from the website of FIG. 21 where a user can opt in to alerts of celebrity sightings according to the geographical location of the sightings in accordance with an embodiment of the present invention. If a user lives in a particular neighborhood, works in a particular neighborhood, or spends a significant amount of time in or around a particular neighborhood for some other reason, that user may be especially interested in alerts in that neighborhood. For one, the user may be able to respond to an alert by traveling to observe the alert. Additionally, many people are particularly interested in events occurring in the areas where they live and work, even when they are unable to attend themselves. Heading 2800 indicates a section of the web page where the user can opt in or out of receiving text messages, while heading 2810 indicates a section of the web page where the user can opt in or out of receiving alerts about sightings in specific geographic locations. Such settings can be used in process 1900 of FIG. 19 to determine user sighting preferences.

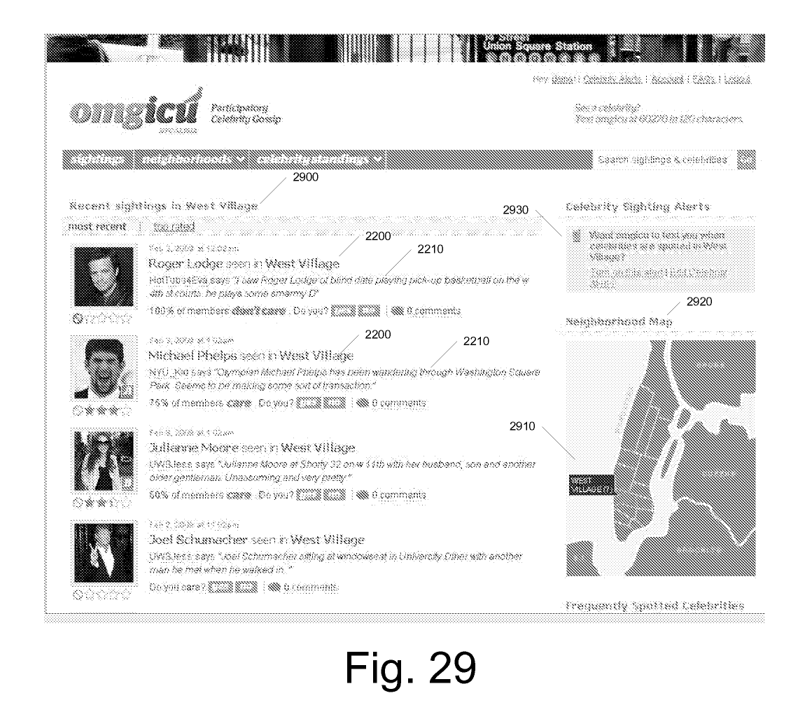

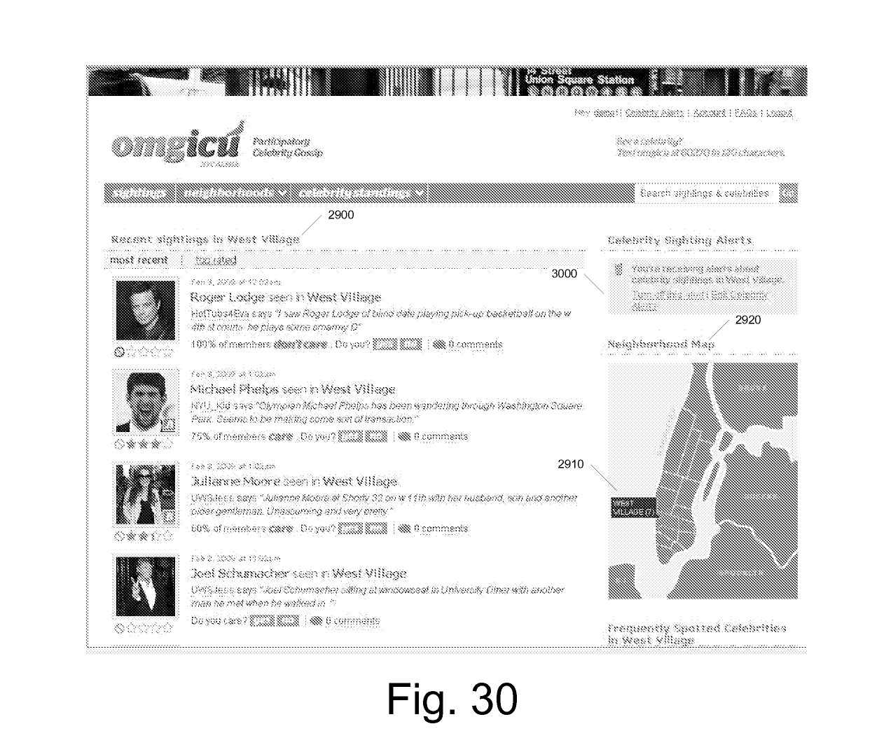

Handling of user preferences relating to geographical location is now discussed with reference to FIGS. 29 and 30. FIG. 29 is a representation of a web page from the website of FIG. 21 inviting a user to opt in to alerts in a particular geographical location, and showing a list of celebrity sightings selected according to the geographical location of the sightings in accordance with an embodiment of the present invention. FIG. 30 is a representation of a web page from the website of FIG. 21 confirming that a user has opted in to alerts in a particular geographical location, and showing a list of celebrity sightings selected according to the geographical location of the sightings in accordance with an embodiment of the present invention. In both FIG. 29 and FIG. 30, heading 2900 indicates that a list of recent sightings in West Village is shown. Neighborhood map 2920 also shows using text box 2910 that sightings for West Village are shown, and also that a total of seven sightings are available for that location. Text prompt 2930 of FIG. 29 asks the user if the system should report celebrity sightings in this neighborhood to the user via text message. Text prompt 2930 provides a link labeled “Turn on this alert,” which if clicked will cause the user to opt in to alerts for this neighborhood, and a web page like the one shown in FIG. 30 will be reached. Clicking “Edit Celebrity Alerts” can cause the user to navigate to the web page shown in FIG. 28. Text prompt 3000 in FIG. 30 indicates that the user has now opted in to alerts in this neighborhood. Clicking on “Turn off this alert” will cause the user to opt out of alerts in this neighborhood, and to navigate back to a web page like the one in FIG. 29.

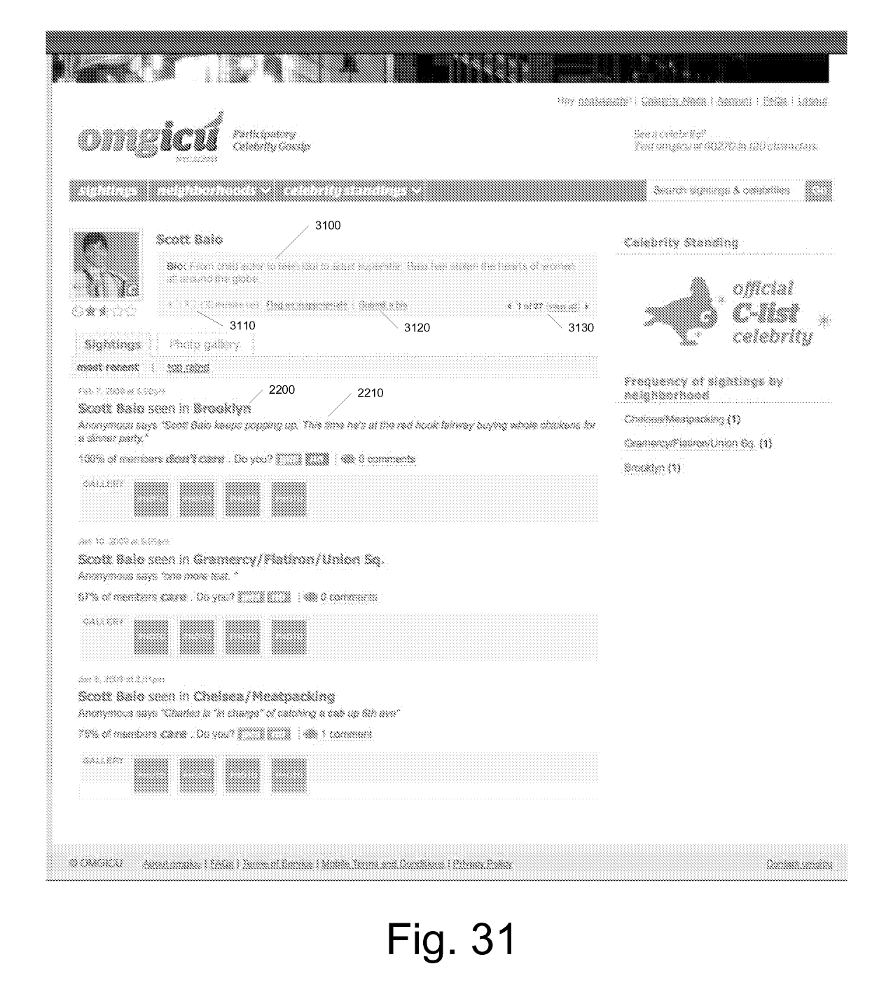

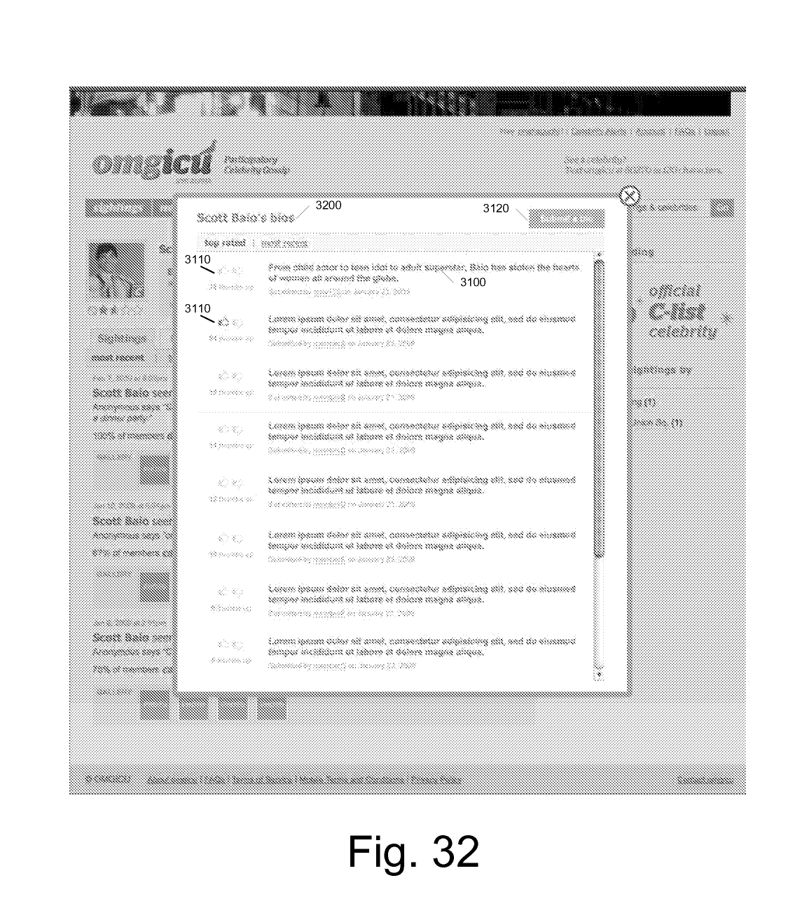

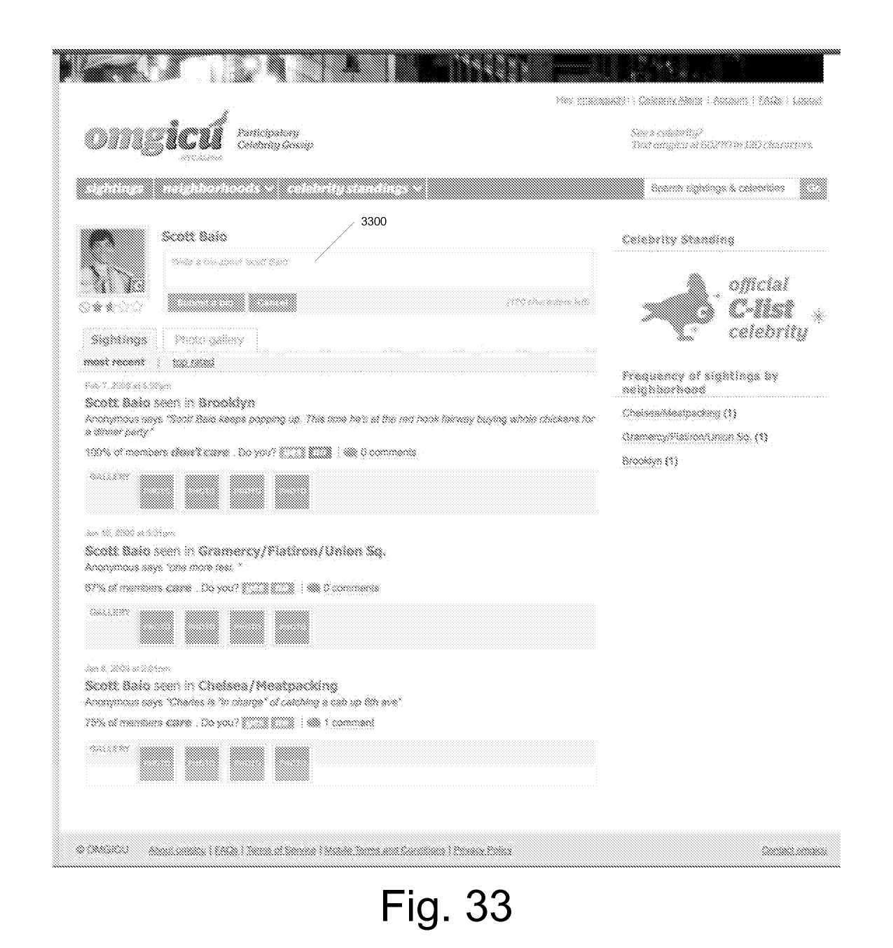

FIG. 31 is a representation of a web page from the website of FIG. 21 showing a profile of a celebrity including a biographical summary. Celebrity database 120 of FIG. 1 may contain multiple biographical summaries for a celebrity. Biographical summary 3100 in FIG. 31 represents the highest rated summary, which is presented to the user first, according to certain embodiments. Biography rating input 3110 allows the user to express approval or disapproval of the summary. Such approval or disapproval can be used in process 610 of FIG. 6, described above, to cause the rating of the summary to be updated accordingly. The user also may follow link 3120 labeled “Submit a bio” and reach a web page similar to the one shown in FIG. 33 and described below. The user may navigate through the available summaries, including following link 3130 labeled “view all,” which causes the user to navigate to a web page similar to the one shown in FIG. 32 and described below.

FIG. 32 is a representation of a web page from the website of FIG. 21 where a user can read user-generated biographical summaries for a celebrity. Heading 3200 indicates that a list of biographical summaries for Scott Baio is shown. At this screen, users can view all summaries 3110 submitted for the selected celebrity, and can rate the summaries using biography rating inputs 3110.

FIG. 33 is a representation of a web page from the website of FIG. 21 where a user can write a biographical summary for a celebrity. The user can write a biographical summary in biography input box 3300. Upon submission, the summary is added to the collection of summaries for the selected celebrity after being received in process 600 of FIG. 6.

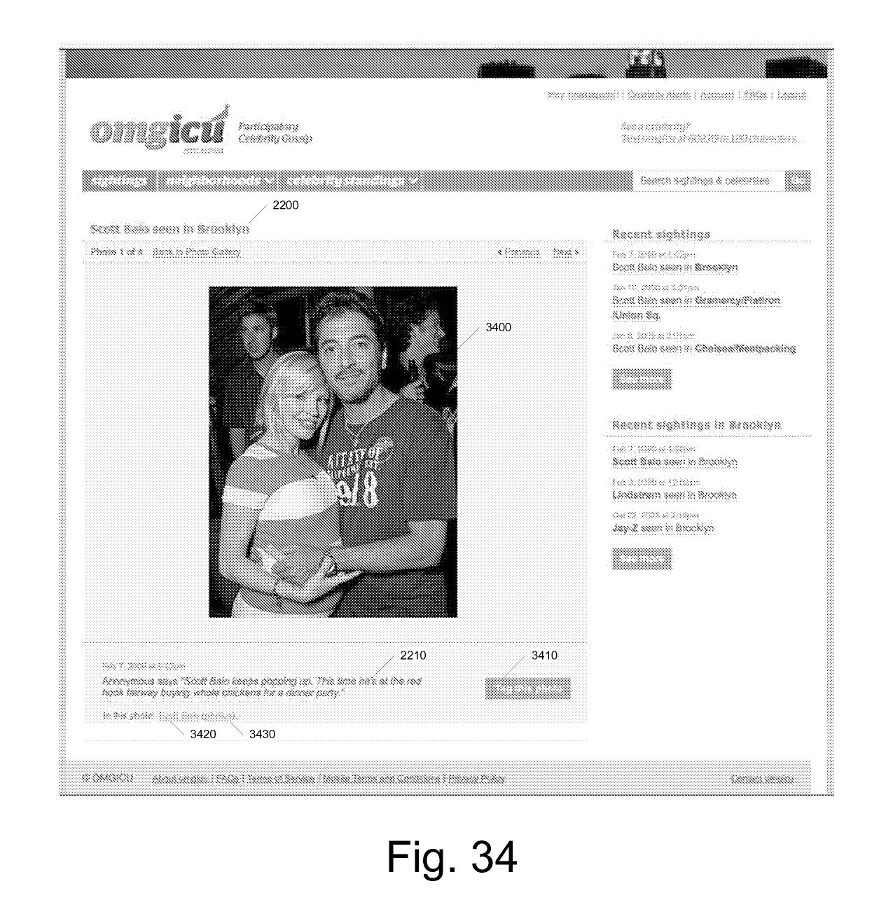

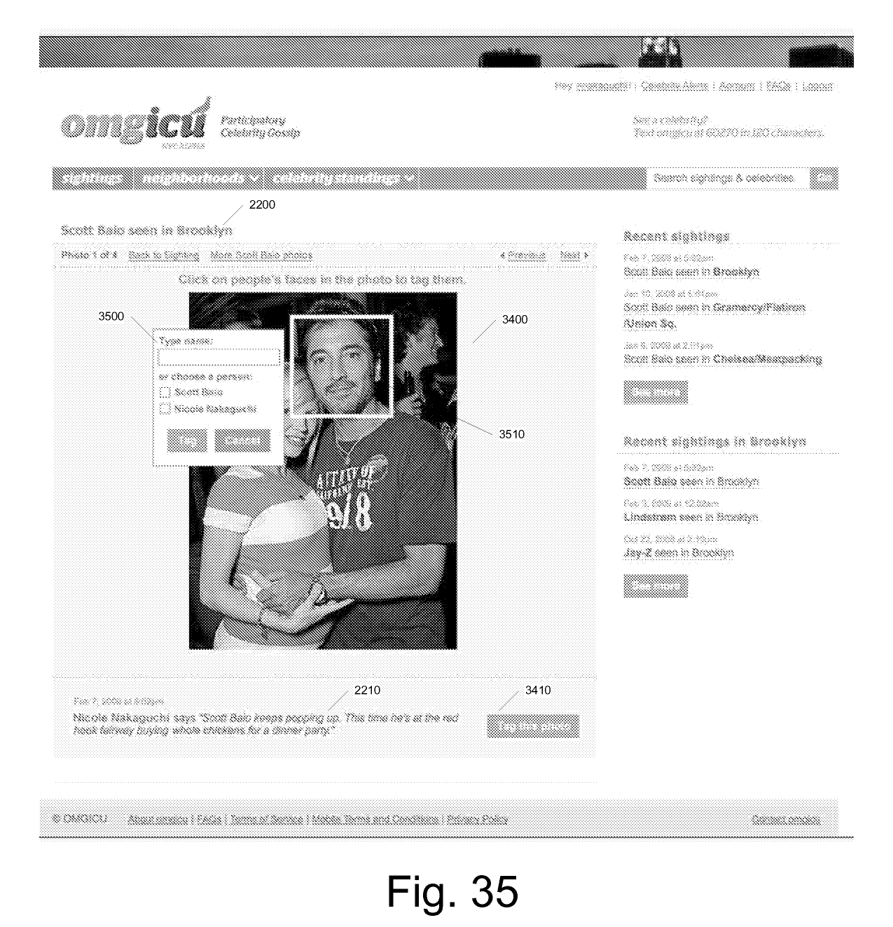

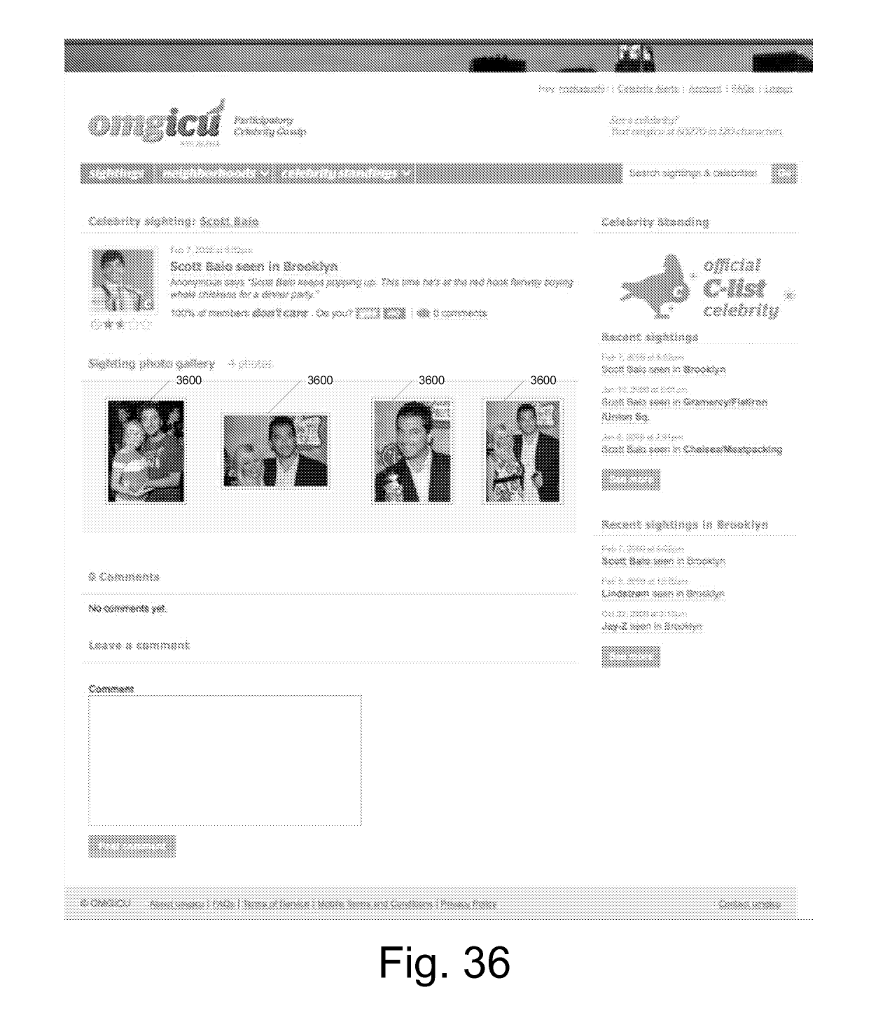

FIG. 34 is a representation of a web page from the website of FIG. 21 showing a published celebrity sighting including a picture of a celebrity with a user. Picture 3400 is a photograph of several people, including celebrity Scott Baio. Picture 3400 demonstrates how a user can submit a picture message documenting a celebrity sighting on the web site, which is received in process 700 of FIG. 7. The user submitting the picture, or in some embodiments, other users, can then load the web page shown in FIG. 34 and click button 3410 labeled “Tag this photo,” bringing up a web page, similar to the one shown in FIG. 35, where the identity of Scott Baio and other persons in picture 3400 can be tagged. Link 3420 allows a user to navigate to a web page such as the one shown in FIG. 24 containing content related to the selected celebrity. Link 3430 allows a user to navigate to a web page such as the one showed in FIG. 36, discussed below, including recent pictures of the selected celebrity.

FIG. 35 is a representation of a web page from the website of FIG. 21 showing a published celebrity sighting where a user can tag a celebrity or a user in a picture. Text entry box 3500 allows a user to associate an identity of a celebrity or user with picture 3400 in process 930 of FIG. 9. The user clicks on a face in picture 3400, causing face outline box 3510 and text entry box 3500 to appear. In text entry box 3500 the user then indicates whose face appears in face outline box 3510, causing the identity of the person to be associated with the picture.

FIG. 36 is a representation of a web page from the website of FIG. 21 showing multiple pictures of a celebrity associated with multiple published sightings of the celebrity. Some celebrities will be represented by multiple pictures, either from users sending multiple pictures to the system for a single event, or from the celebrity being sighted in multiple events. In FIG. 36 multiple pictures 3600 of a celebrity make up a sighting photo gallery for a celebrity, where recent sighting photos can be found.

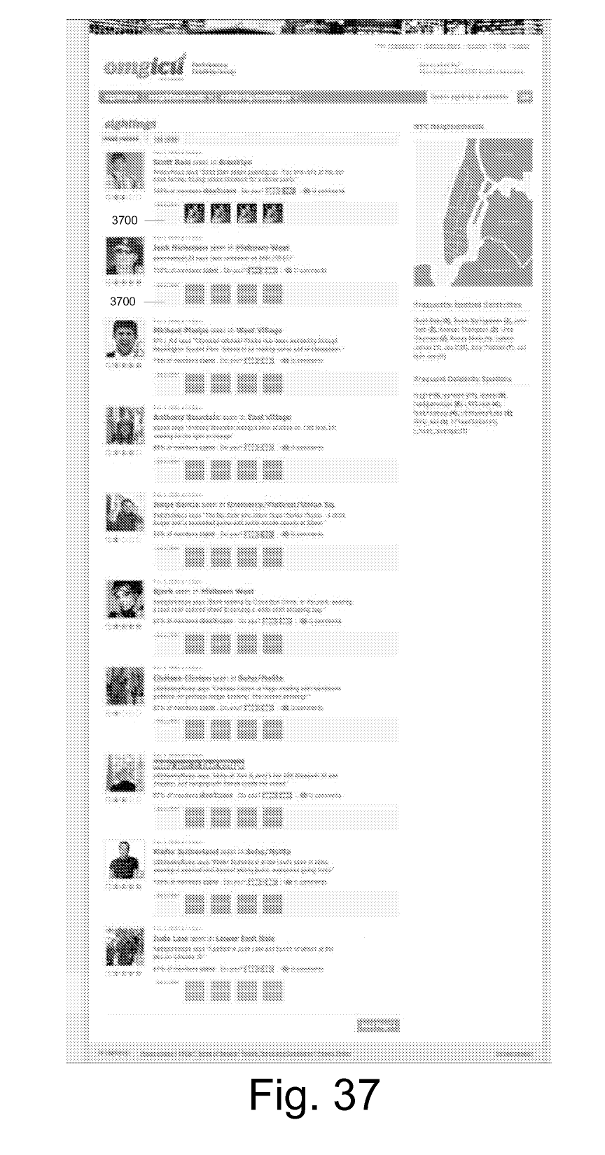

FIG. 37 is a representation of a web page from the website of FIG. 21 showing a list of published celebrity sightings, in which one of the sightings includes pictures of the sighting. The web page shown in FIG. 37 includes a list of celebrity sightings similar to the web page shown in FIG. 22. Each sighting also includes a small photo gallery 3700, showing recent pictures associated with the sighting. In some embodiments the gallery will show recent pictures associated with the celebrity, irrespective of whether the most recent sighting includes pictures or not. If the sighting itself does not have any associated pictures, or does not have enough to fill the gallery (four, in this embodiment), then the next most recent pictures of the celebrity may be used. In some cases, no pictures will be available for a celebrity, in which case photo gallery 3700 may be blank, as shown in FIG. 37 for the sighting of Jack Nicholson. In other embodiments photo gallery 3700 can be omitted from sightings that do not include any pictures of the celebrity.

The present invention may be embodied in many different forms, including, but in no way limited to, computer program logic for use with a processor (e.g., a microprocessor, microcontroller, digital signal processor, or general purpose computer), programmable logic for use with a programmable logic device (e.g., a Field Programmable Gate Array (FPGA) or other PLD), discrete components, integrated circuitry (e.g., an Application Specific Integrated Circuit (ASIC)), or any other means including any combination thereof.

Computer program logic implementing all or part of the functionality previously described herein may be embodied in various forms, including, but in no way limited to, a source code form, a computer executable form, and various intermediate forms (e.g., forms generated by an assembler, compiler, linker, or locator). Source code may include a series of computer program instructions implemented in any of various programming languages (e.g., an object code, an assembly language, or a high-level language such as Fortran, C, C++, JAVA, or HTML) for use with various operating systems or operating environments. The source code may define and use various data structures and communication messages. The source code may be in a computer executable form (e.g., via an interpreter), or the source code may be converted (e.g., via a translator, assembler, or compiler) into a computer executable form.

The computer program may be fixed in any form (e.g., source code form, computer executable form, or an intermediate form) in a tangible storage medium, such as a semiconductor memory device (e.g., a RAM, ROM, PROM, EEPROM, or Flash-Programmable memory), a magnetic memory device (e.g., a diskette or fixed disk), an optical memory device (e.g., a CD-ROM), a PC card (e.g., PCMCIA card), or other memory device. The computer program may be distributed in any form as a removable storage medium with accompanying printed or electronic documentation (e.g., shrink wrapped software), preloaded with a computer system (e.g., on system ROM or fixed disk), or distributed from a server or electronic bulletin board over the communication system (e.g., the Internet or World Wide Web).

Hardware logic (including programmable logic for use with a programmable logic device) implementing all or part of the functionality previously described herein may be designed using traditional manual methods, or may be designed, captured, simulated, or documented electronically using various tools, such as Computer Aided Design (CAD), a hardware description language (e.g., VHDL or AHDL), or a PLD programming language (e.g., PALASM, ABEL, or CUPL).

Programmable logic may be fixed either permanently or transitorily in a tangible storage medium, such as a semiconductor memory device (e.g., a RAM, ROM, PROM, EEPROM, or Flash-Programmable memory), a magnetic memory device (e.g., a diskette or fixed disk), an optical memory device (e.g., a CD-ROM), or other memory device. The programmable logic may be distributed as a removable storage medium with accompanying printed or electronic documentation (e.g., shrink wrapped software), preloaded with a computer system (e.g., on system ROM or fixed disk), or distributed from a server or electronic bulletin board over the communication system (e.g., the Internet or World Wide Web).

The embodiments of the invention described above are intended to be merely exemplary; numerous variations and modifications will be apparent to those skilled in the art. All such variations and modifications are intended to be within the scope of the present invention as defined in any appended claims.

What is claimed is:

1. A computer-implemented method of providing a real-time participatory experience of localized event information, the method comprising:
receiving over a communications network a collection of messages, each message involving a localized event;
storing messages of the collection; and
with respect to each message of the collection,
in a first computer process, extracting an identity of the sender from the message, and updating a user database based on the sender's identity;
in a second computer process, parsing the message to derive a location from the message about the event;
storing in an event database the derived location in association with the event;
retrieving, from a user database, a list of users and notification parameters; and
in a third computer process, generating a contemporaneous alert reporting on information stored in the event database and causing the alert to be sent over the communications network to the users on the list in accordance with the notification parameters.

2. A computer-implemented method of providing a real-time participatory experience of localized event information about celebrities, the method comprising:
receiving over a communications network a collection of messages, each message involving a celebrity in a localized event;
storing messages of the collection; and
with respect to each message of the collection,
in a first computer process, extracting an identity of the sender from the message, and updating a user database based on the sender's identity and authenticating the sender;
in a second computer process, parsing the message (i) to associate the message with an identity of the celebrity and (ii) to derive a location from the message about the celebrity;
storing in a celebrity database the derived location in association with the celebrity;
retrieving, from a user database, a list of users and notification parameters; and
in a third computer process, generating a contemporaneous alert reporting on information stored in the celebrity database and causing the alert to be sent over the communications network to the users on the list in accordance with the notification parameters.

3. A method according to claim 2, further comprising:
receiving over the communications network a communication from at least one of the users receiving the alert, such communication evaluative of content of the alert; and
updating the user database to reflect the evaluative communication.

4. A method according to claim 3, further comprising:
updating the celebrity database to reflect the evaluative communication.

5. A method according to claim 2, wherein the identity of the celebrity and the identity of the sender are distinct.

6. A method according to claim 2, wherein each message involving a celebrity in a localized event comprises a text message sent by a sender who has observed the celebrity in the localized event.

7. A method according to claim 2, further comprising operating a web server to cause publication of the event on a web site.

8. A method according to claim 7, wherein operating the web server to cause publication of the event on a web site includes for each of a set of words in the associated message, providing a link on the web site to content on the web site, the content being associated with the word.

9. A method according to claim 3, wherein updating the user database to reflect a communication evaluative of content of an alert includes adjusting at least one ranking for the sender of the alert.

10. A method according to claim 4, wherein updating the celebrity database to reflect the communication includes adjusting at least one ranking for the celebrity.

11. A method according to claim 3, wherein a communication evaluative of content of an alert includes a measure of relevance of the alert.

12. A method according to claim 3, wherein a communication evaluative of content of an alert includes a measure of validity of the alert.

13. A method according to claim 6, wherein each message includes a user-generated description of the localized event.

14. A method according to claim 13, wherein the user-generated description of the localized event is not selected from a predetermined set of descriptions.

15. A method according to claim 2, wherein the collection of messages includes at least one message containing a picture of a celebrity.

16. A method according to claim 15, wherein the picture of a celebrity is a picture of the celebrity with a user.

17. A method according to claim 15, further comprising:
associating the picture of the celebrity with an identity of the celebrity; and
providing a link on the web site to content on the web site, the content being associated with the identity of the celebrity.

18. A method according to claim 16, further comprising:
associating the picture of the celebrity and user with an identity of the user; and
providing a link on the web site to content on the web site, the content being associated with the identity of the user.

19. A method according to claim 15, wherein the at least one picture message includes a text message.

20. A method according to claim 2, further comprising receiving over the communications network a message from a user receiving an alert, the message including a picture of the event.

21. A system for providing a real-time participatory experience of localized event information about a celebrity, the system comprising:
a communications interface configured to receive and send communications over a communications network via at least one of a message gateway and a web server, the communications including messages, each message involving a celebrity in a localized event;
a user database;
a celebrity database;
an identity extractor, coupled to the communications interface, configured to extract an identity of a sender from each of the messages, and further configured to update the user database for each message based on an identity of a sender of the message and to authenticate the sender;
a message parser, coupled to the communications interface, configured for each of the messages to parse the message (i) to associate the message with an identity of the celebrity and (ii) to derive a location from the message about the celebrity, and further configured to update the celebrity database based on the identity of the celebrity and the location;
a processing unit, configured to generate notification parameters and store the parameters in the user database; and
an alert generator, configured for each of the messages to retrieve from the user database (i) a list of users associated with the location, and (ii) notification parameters, and further configured for each of the messages to generate an alert reporting on the event and cause the alert to be sent over the communications network to the users on the list via at least the message gateway.

22. A system according to claim 21, wherein the processing unit is further configured to:
receive over the communications network via at least one of the message gateway and the web site a communication from at least one of the users receiving an alert, such communication evaluative of content of the alert; and
update the user database to reflect the evaluative communication.

23. A system according to claim 22, wherein the processing unit further configured to update the celebrity database to reflect the evaluative communication.

24. A system according to claim 21, wherein the message gateway is an SMS gateway.

25. A method of generating information relating to an online identity of a set of individuals, the method comprising:
receiving over a communications network a collection of messages, each message involving a celebrity in a localized event;
storing messages of the collection; and
with respect to each message of the collection,
in a first computer process, extracting an identity of the sender from the message, and updating a user database based on the sender's identity and authenticating the sender;
in a second computer process, parsing the message (i) to associate the message with an identity of the celebrity and (ii) to derive a location from the message about the celebrity;
storing in a celebrity database the derived location in association with the celebrity;
retrieving, from a user database, a list of users and notification parameters;
in a third computer process, generating a contemporaneous alert reporting on information stored in the celebrity database and causing the alert to be sent over the communications network to the users on the list in accordance with the notification parameters;
receiving over the communications network a communication from at least one of the users receiving the alert, such communication evaluative of the content of the alert; and
updating the user database and the celebrity database to reflect the evaluative communication;
receiving over the communications network, from a plurality of users, biographical summaries of the celebrity;
assigning a ranking to each of the biographical summaries;
receiving over the communications network, from a user receiving the alert, a message requesting a biographical summary relating to the celebrity; and
sending over the communications network, to the user requesting the summary, a message containing a biographical summary selected from the biographical summaries according to the rankings.

26. A method according to claim 25, further comprising:
receiving over the communications network, from the user requesting the summary, a communication evaluative of the summary; and
updating the ranking of the biographical summary according to the communication evaluative of the summary.

27. A method according to claim 25, further comprising:
receiving over the communications network, from the user requesting the summary, a message requesting a second biographical summary; and
sending over the communications network, to the user, a message containing a second biographical summary selected from the biographical summaries according to the rankings.

28. A method according to claim 25, further comprising:
updating the notification parameters based on the request for a biographical summary.

29. A method according to claim 25, the method further comprising generating information relating to an online identity of a celebrity according to the number of biographical summaries received from users for the celebrity and storing the information relating to the online identity in the celebrity database.
